(19) United States
(12) Patent Application Publication
(10) Pub. No.: US 2025/0283804 A1
(43) Pub. Date: Sep. 11, 2025

(54) SYSTEMS AND METHODS OF THREE-DIMENSIONAL IMAGING USING A TWO-DIMENSIONAL SENSOR

(71) Applicant: Huron Technologies International Inc., St. Jacobs (CA)

(72) Inventors: Arthur Edward Dixon, St. Jacobs (CA); Savvas Damaskinos, St. Jacobs (CA); Alfonso Ribes, St. Jacobs (CA); Jasper Hayes, St. Jacobs (CA)

(21) Appl. No.: 19/072,435

(22) Filed: Mar. 6, 2025

Related U.S. Application Data
(60) Provisional application No. 63/562,017, filed on Mar. 6, 2024.

(51) Int. Cl. G01N 21/17; G06T 15/00

(52) U.S. Cl. CPC G01N 21/17; G06T 15/005; G01N 2021/1765; G01N 2021/1785

(57) ABSTRACT

Instruments and methods of obtaining a three-dimensional image of a biological specimen are described herein. The methods include capturing a first image of a first frame of the specimen using a sensor array. The first frame is an in-focus area of the specimen at a first depth level of the specimen. The specimen is then moved relative to the sensor array in a scanning direction by a predetermined number of rows of pixels. A second image of a second frame of the specimen is captured using the sensor array. The second frame is an in-focus area of the specimen at a second depth level of the specimen. The second depth level is spaced apart from the first depth level in a direction perpendicular to the scanning direction. The first image and the second image are processed to obtain the three-dimensional image of the specimen.

### CROSS REFERENCE TO RELATED APPLICATIONS

The present application claims the benefit of U.S. Provisional Patent Application 63/562,017 entitled “Systems and Methods of Three-Dimensional Imaging Using a Two-Dimensional Sensor” filed on Mar. 6, 2024, the entire contents of which are hereby incorporated by reference in their entirety.

### TECHNICAL FIELD

The present disclosure relates to biological specimen imaging methods and systems, and more specifically to creation of three-dimensional or extended-focus images of biological specimens using a computer-controlled scanning-stage.

### BACKGROUND

Many different scanning technologies currently exist for imaging biological specimens and creating three-dimensional images thereof.

Oftentimes, these technologies require the camera and/or the specimen to tilt in order to obtain images of various depths of the biological specimen. Additionally, existing technologies require complex image processing algorithms and expensive and/or cumbersome equipment.

There is a need for a new and improved systems and methods of imaging that are, optionally, compatible with use of moving specimen image averaging (MSIA) and obviate at least one of the disadvantages noted above.

### SUMMARY

In accordance with a broad aspect, a computer implemented method of obtaining a three-dimensional image of a biological specimen is described herein. The method includes operating a processor to: capture a first image of a first frame of the specimen using a color or monochrome area sensor array when the specimen is at a first position, the first frame having a plurality of rows of pixels and being an in-focus area of the specimen at a first depth level of the specimen; move the specimen relative to the color or monochrome area sensor array in a scanning direction by a predetermined number of rows of pixels; capture a second image of a second frame of the specimen using the color or monochrome area sensor array when the specimen is at a second position, the second frame having the plurality of rows of pixels and being an in-focus area of the specimen at a second depth level of the specimen, the second depth level being spaced apart from the first depth level in a direction perpendicular to the scanning direction; and process the first image and the second image to obtain the three-dimensional image of the specimen.

In at least one embodiment, the processor is operable to move the specimen relative to the color or monochrome area sensor array in the scanning direction at a constant velocity.

In at least one embodiment, the processor is operable to move the specimen relative to the color or monochrome area sensor array in the scanning direction by the predetermined number of rows of pixels; capture a third image of a third frame of the specimen using the color or monochrome area sensor array when the specimen is at a third position, the third frame having the plurality of rows of pixels and being an in-focus area of the specimen at a third depth level of the specimen, the third depth level being spaced apart from the first depth level and the second depth level in the direction perpendicular to the scanning direction; and process the first image, the second image and the third image to obtain the three-dimensional image of the specimen.

In at least one embodiment, the capture of the first image and the capture of the second image are separated by a first time interval and the capture of the second image and the capture of the third image are separated by a second time interval, the first time interval and the second time interval having the same duration.

In at least one embodiment, the processor is operable to, after the capture of the third image, the processor is operable to move the specimen relative to the color or monochrome area sensor array in the scanning direction by the predetermined number of rows of pixels; capture a fourth image of a fourth frame of the specimen using the color or monochrome area sensor array when the specimen is at a fourth position, the fourth frame having the plurality of rows of pixels and being an in-focus area of the specimen at a fourth depth level of the specimen, the fourth depth level being spaced apart from the first depth level, the second depth level and the third depth level in the direction perpendicular to the scan direction; and process the first image, the second image, the third image and the fourth image to obtain the three-dimensional image of the specimen.

In at least one embodiment, the processor is operable to, after the capture of the third image, move the specimen relative to the color or monochrome area sensor array in the scanning direction by the predetermined number of rows of pixels; capture a fourth image of a fourth frame of the specimen using the color or monochrome area sensor array when the specimen is at a fourth position, the fourth frame having the plurality of rows of pixels and being an in-focus area of the specimen at a fourth depth level of the specimen, the fourth depth level being spaced apart between the first depth level and the second depth level in the direction perpendicular to the scan direction; and process the first image, the second image, the third image and the fourth image to obtain the three-dimensional image of the specimen.

In at least one embodiment, the processor is operable to, after the capture of the fourth image, move the specimen relative to the color or monochrome area sensor array in the scanning direction by the predetermined number of rows of pixels; capture a fifth image of a fifth frame of the specimen using the color or monochrome area sensor array when the specimen is at a fifth position, the fifth frame having the plurality of rows of pixels and being an in-focus area of the specimen at a fifth depth level of the specimen, the fifth depth level being spaced apart from the first depth level, the second depth level, the third depth level and the fourth depth level in the direction perpendicular to the scan direction; and process the first image, the second image, the third image, the fourth image and the fifth image to obtain the three-dimensional image of the specimen.

In at least one embodiment, the processor is operable to, after the capture of the fourth image, move the specimen relative to the color or monochrome area sensor array in the scanning direction by the predetermined number of rows of pixels; capture a fifth image of a fifth frame of the specimen using the color or monochrome area sensor array when the specimen is at a fifth position, the fifth frame having the plurality of rows of pixels and being an in-focus area of the specimen at a fifth depth level of the specimen, the fourth depth level being between the second depth level and the third depth level in the direction perpendicular to the scan direction and the fifth depth level being between the first depth level and the second depth level in the direction perpendicular to the scan direction; and process the first image, the second image, the third image, the fourth image and the fifth image to obtain the three-dimensional image of the specimen.

In at least one embodiment, the capture of the first image includes an illumination source, synchronized with triggering the camera and opening a shutter of the camera to expose the sensor to light from the light source, the light source being on for a duration of the scan.

In at least one embodiment, the capture of the first image includes an illumination source synchronized with triggering the camera and opening a shutter of the camera to expose the sensor to light from the light source for an exposure time, the illumination of the light source being pulsed with a pulse width greater than the exposure time.

In at least one embodiment, the capture of the first image includes an illumination source synchronized with triggering the camera and opening a shutter of the camera to expose the sensor to light from the light source for an exposure time, the illumination of the light source being pulsed with a pulse width less than the exposure time.

In at least one embodiment, the capture of the first image includes an illumination source synchronized with triggering the camera and opening a shutter of the camera to expose the sensor to light from the light source for an exposure time, the light source being a color (RGB) light source.

In at least one embodiment, the illumination source is pulsed with a pulse width greater than the exposure time of each R, G, and B illumination pulse.

In at least one embodiment, the illumination source is pulsed with a pulse width less than the exposure time of each R, G, and B illumination pulse.

In at least one embodiment, the processing the first image, the second image and the third image to obtain the three-dimensional image of the specimen includes processing the first image, the second image and the third image using Moving Specimen Image Averaging (MSIA).

In accordance with a broad aspect, an instrument for obtaining a three-dimensional image of a biological specimen (e.g. mounted on slide, such as but not limited to a pathology slide) is described herein. The instrument includes a processor configured to: capture a first image of a first frame of the specimen using a color or monochrome area sensor array when the specimen is at a first position, the first frame having a plurality of rows of pixels and being an in-focus area of the specimen at a first depth level of the specimen; move the specimen relative to the color or monochrome area sensor array in a scanning direction by a predetermined number of rows of pixels; capture a second image of a second frame of the specimen using the color or monochrome area sensor array when the specimen is at a second position, the second frame having the plurality of rows of pixels and being an in-focus area of the specimen at a second depth level of the specimen, the second depth level being spaced apart from the first depth level in a direction perpendicular to the scanning direction; and process the first image and the second image to obtain the three-dimensional image of the specimen.

### BRIEF DESCRIPTION OF THE DIAGRAMS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

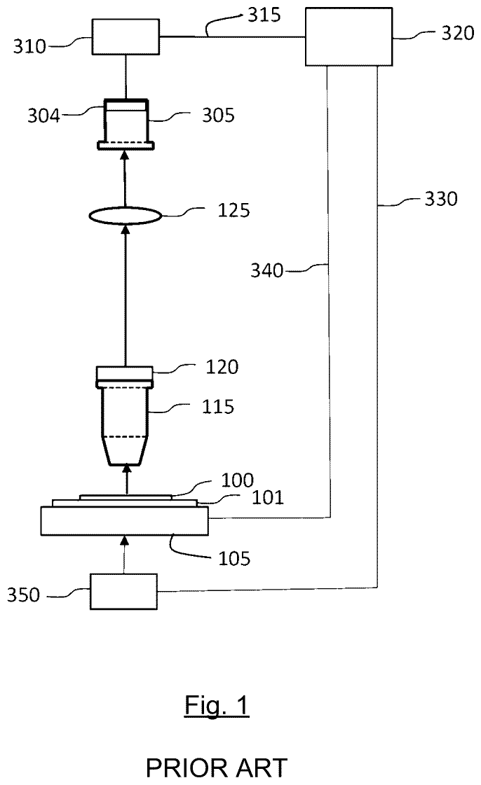

FIG. 1 is a schematic view of a brightfield microscope slide scanner using an area detector array.

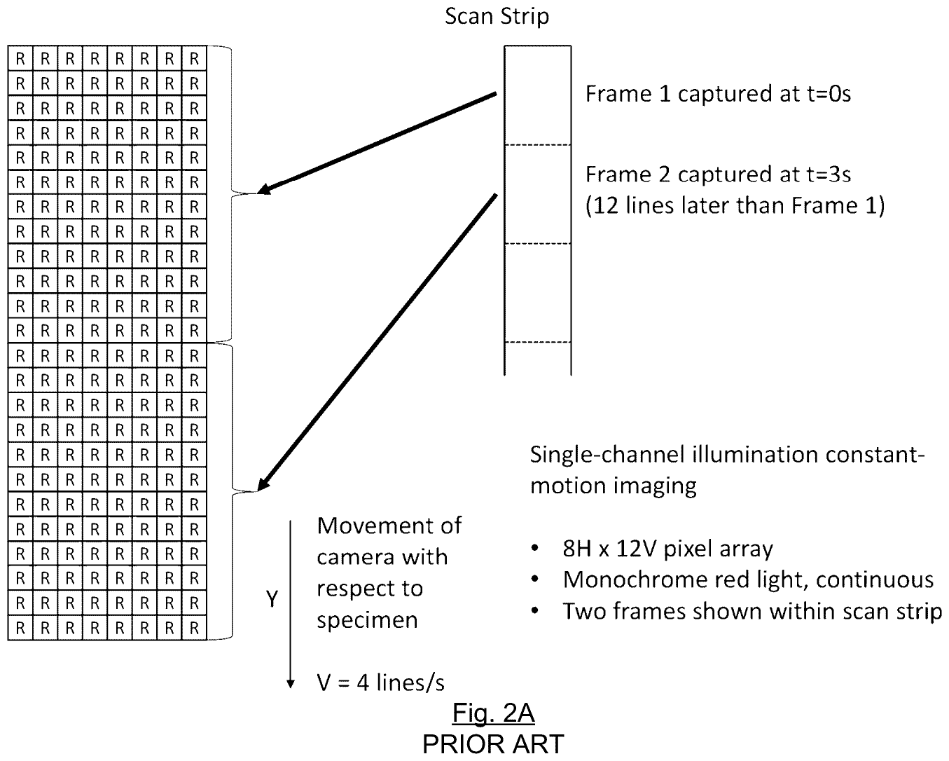

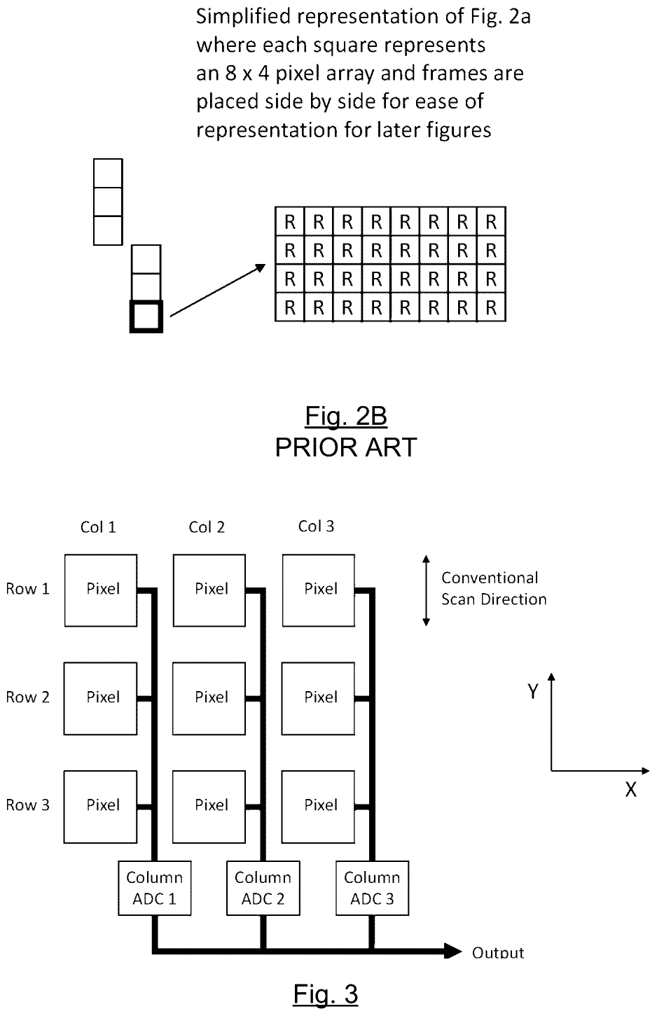

FIG. 2a shows the capture of frame images when the scanner of FIG. 1 is used with sequential exposure of non-overlapping frame images (within a channel such as red) in a single scan.

FIG. 2b shows the constant-motion imaging as in FIG. 2a in a simplified representation that will be useful to compare and contrast with later figures involving MSIA.

FIG. 3 shows an example of a typical area array CMOS sensor structure consisting of rows and columns of pixels. Pixels feed into column ADCs which are common to the entire column.

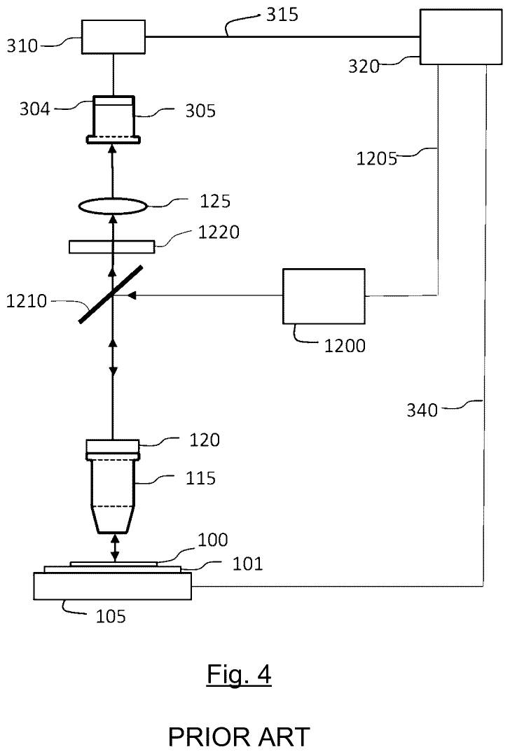

FIG. 4 is a schematic view of a fluorescence microscope slide scanner using an area detector array.

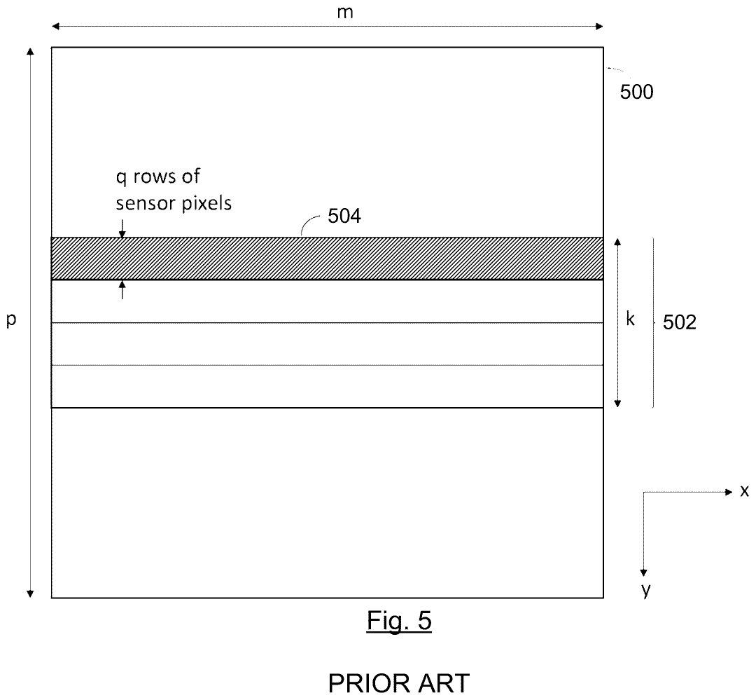

FIG. 5 is a schematic view of a sensor area array of p rows by m columns of pixels showing a window area of k rows by m columns that is further subdivided into equal size of windows of q rows by m column pixels.

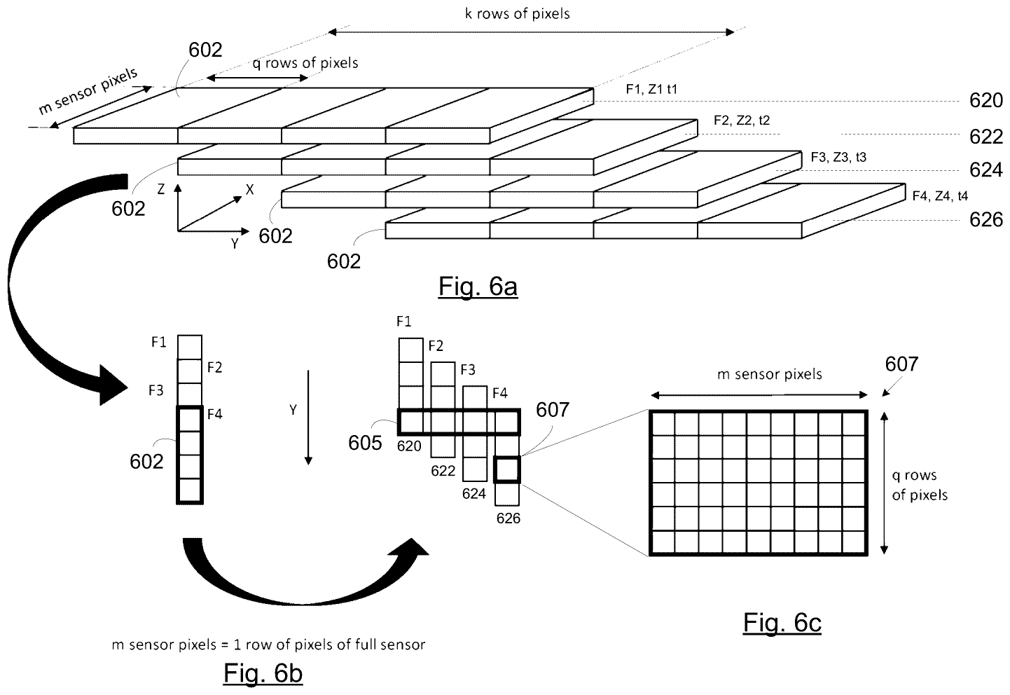

FIG. 6a shows a three-dimensional (3D) view of an example of constant velocity y-motion imaging where four depth (z-motion) levels of a specimen are captured in a single y-motion scan using a windowed color or monochrome area sensor array.

FIG. 6b shows the top view of FIG. 6a example of constant velocity y-motion imaging where four depth (z-motion) levels of a specimen are captured in a single y-motion scan using a windowed color or monochrome area sensor array.

FIG. 6c shows a top view of FIG. 6a example of constant velocity y-motion imaging where four depth (z-motion) levels of a specimen are captured in a single y-motion scan using a windowed color or monochrome area sensor array. For illustration purposes the acquired frames are displaced laterally to show the four depth (z-motion) levels acquired during the acquisition process.

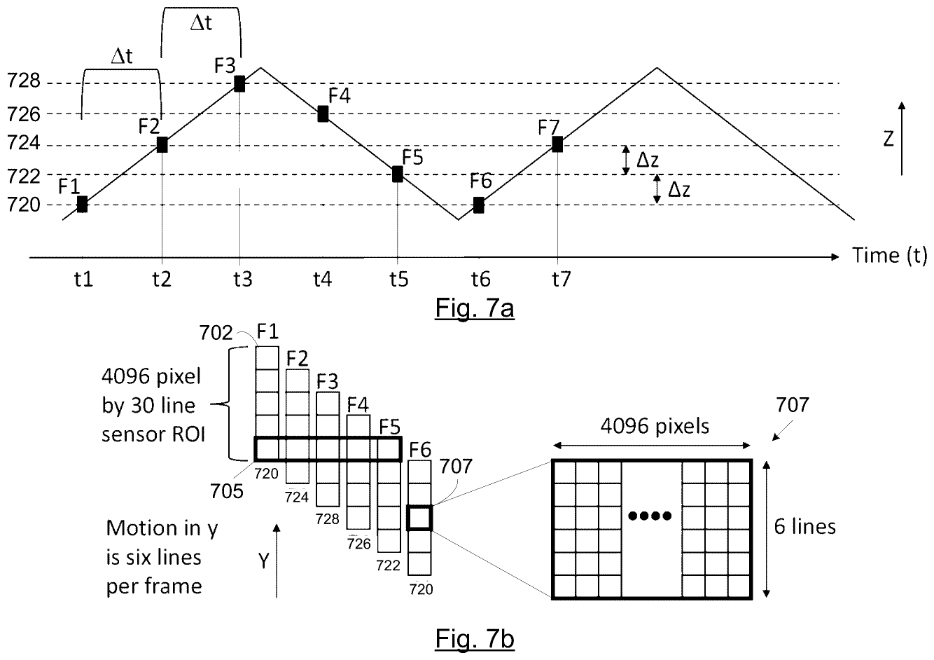

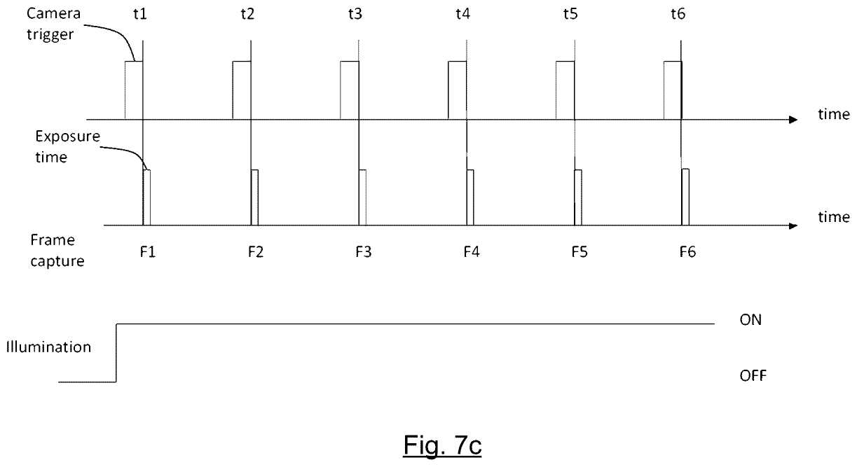

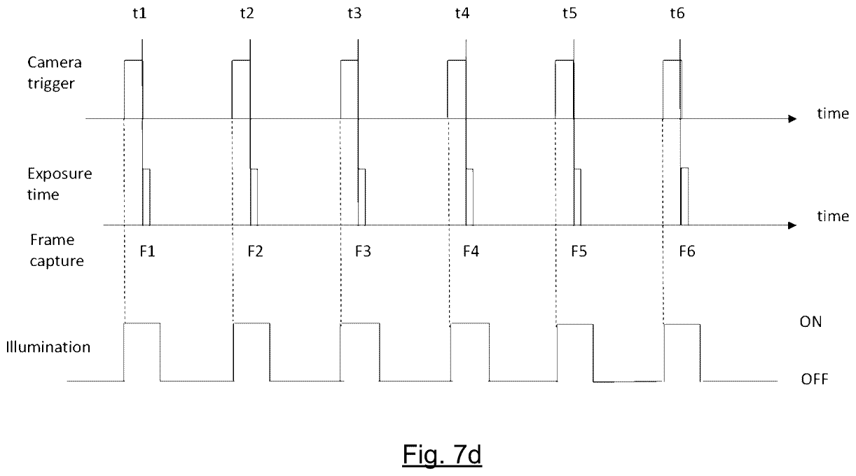

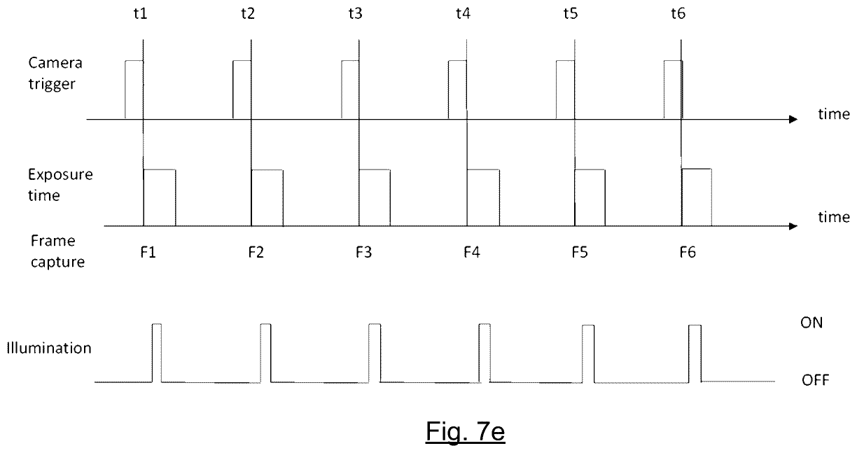

FIG. 7a is one example of z-motion timing diagram of constant velocity y-motion imaging to acquire five depth levels in a scan acquisition workflow.

FIG. 7b is an example top view schematic diagram of constant velocity y-motion where five depth (z-motion) levels of a specimen are captured in a single y-motion scan using a windowed color or monochrome area sensor array as described in the z-motion timing diagram of FIG. 7a.

FIG. 7c is an example timing diagram of camera trigger, camera exposure time, frame capture, and illumination showing one period of motion as described in FIGS. 7a, and 7b where frames F1, F2, F3, F4, F5, F6, F7, . . . , etc. are acquired at points on the repeating “triangular” waveform when the z-motion is at constant velocity. The exposure time is less than one pixel of y-motion, and the illumination is ON and continues for the duration of the scan length. The camera can be color or monochrome, and the illumination can be color or monochrome.

FIG. 7d is an example timing diagram of camera trigger, camera exposure time, frame capture, and illumination showing one period of motion as described in FIGS. 7a, and 7b where frames F1, F2, F3, F4, F5, F6, F7, . . . , etc. are acquired at points on the repeating “triangular” waveform when the z-motion is at constant velocity. The exposure time is less than one pixel of y-motion, and the illumination is pulsed with a pulsed width greater than the camera exposure time. The camera can be color or monochrome, and the illumination can be color or monochrome.

FIG. 7e is an example timing diagram of camera trigger, camera exposure time, frame capture, and illumination showing one period of motion as described in FIGS. 7a, and 7b where frames F1, F2, F3, F4, F5, F6, F7, . . . , etc. are acquired at points on the repeating “triangular” waveform when the z-motion is at constant velocity. The exposure time is less than one pixel of y-motion, and the illumination is pulsed with a pulse width less than the camera exposure time. The pulsed illumination is inside the camera exposure time. The camera can be color or monochrome, and the illumination can be color or monochrome.

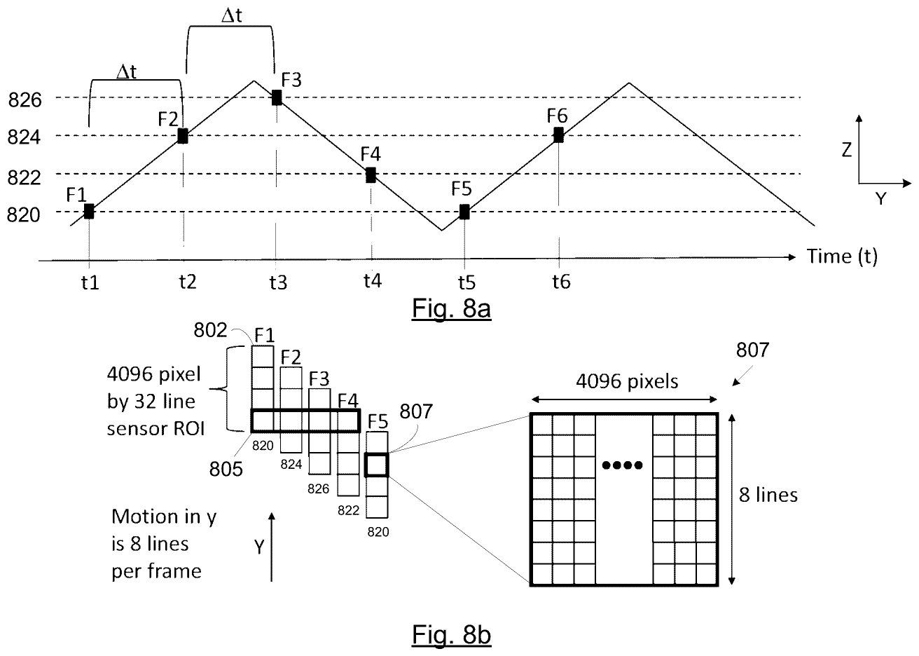

FIG. 8a is another example of z-motion timing diagram to acquire four depth levels in a scan acquisition workflow.

FIG. 8b is another example top view schematic diagram of constant y-motion where four depth (z-motion) levels of a specimen are captured in a single y-motion scan using a windowed color or monochrome area sensor array as described in the z-motion timing diagram of FIG. 8a.

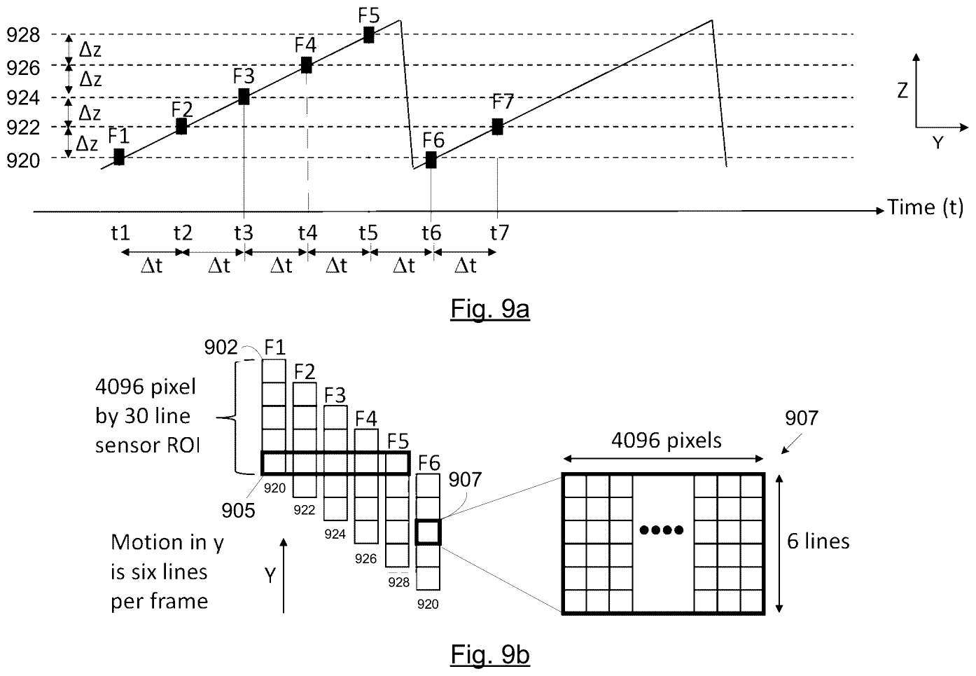

FIG. 9a is one more example of z-motion timing diagram to acquire five depth levels in a scan acquisition workflow.

FIG. 9b is one more example top view schematic diagram of constant y-motion where five depth (z-motion) levels of a specimen are captured in a single y-motion scan using a windowed color or monochrome area sensor array as described in the z-motion timing diagram of FIG. 9a.

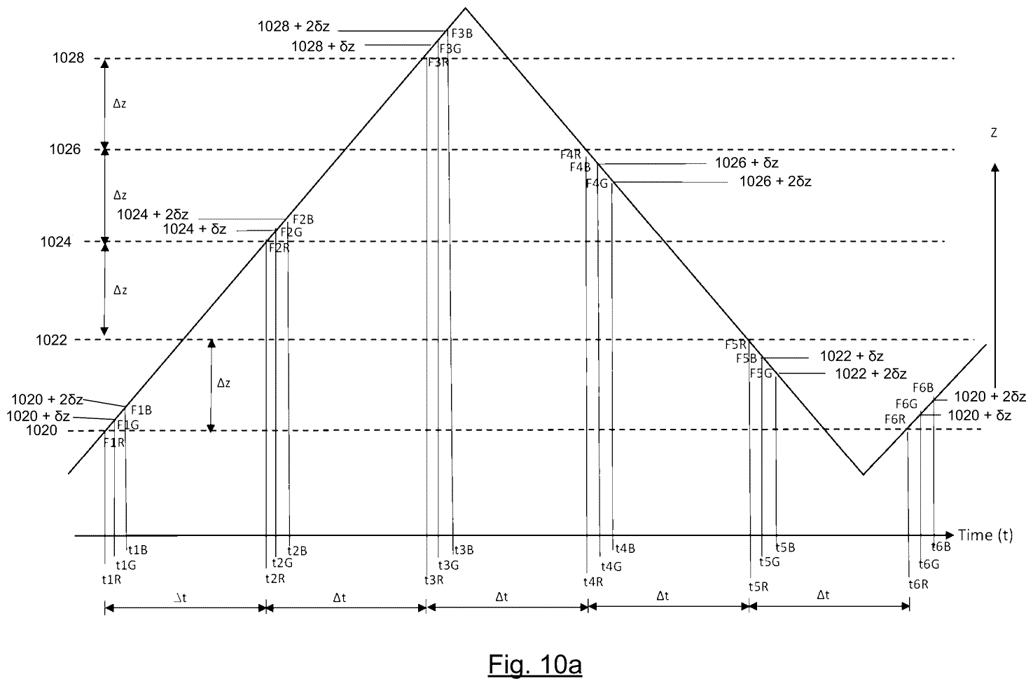

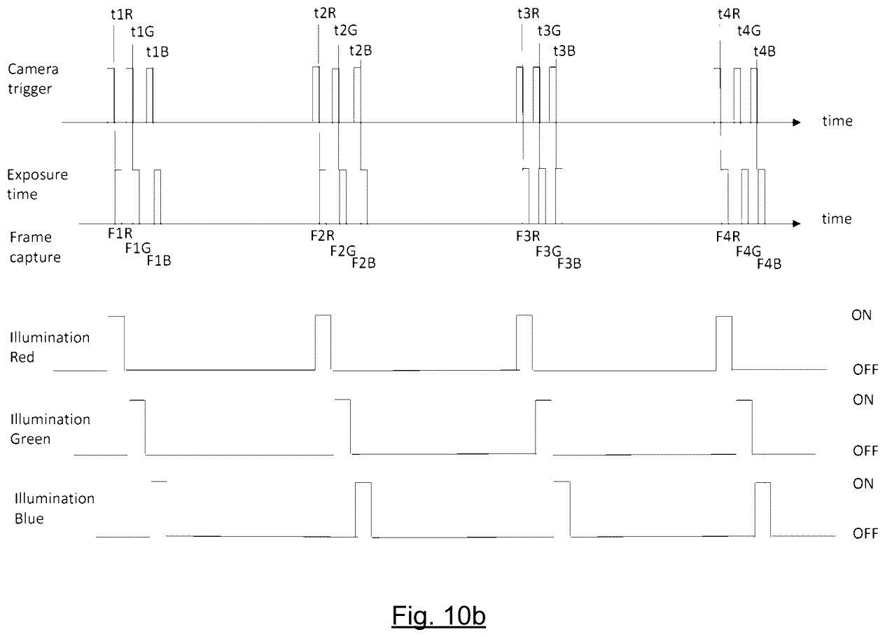

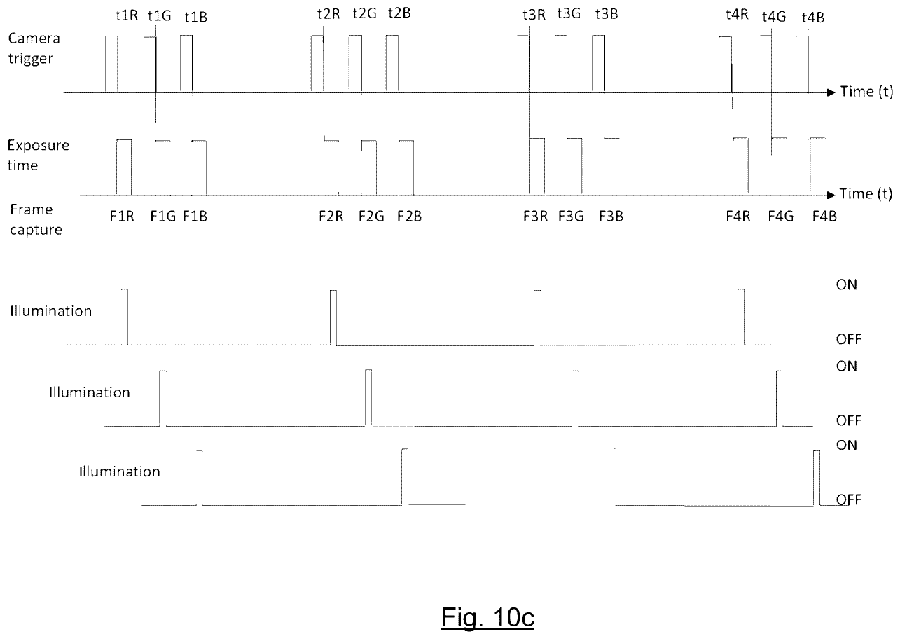

FIG. 10a is an example of z-motion diagram to acquire five depth levels in a scan acquisition workflow using pulsed R, G, B illumination.

FIG. 10b is an example timing diagram of camera trigger, camera exposure time, frame capture, and illumination of a constant y-motion scan shown in FIG. 10a. The camera is monochrome, the illumination is color (RGB). The R, G, B illumination is pulsed with the pulse width greater than the camera exposure time of each R, G, B illumination pulses. Each R, G, B pulse width is less than ⅓ pixel of constant y-motion scan.

FIG. 10c is another example timing diagram of camera trigger, camera exposure time, frame capture, and illumination of a constant y-motion scan shown in FIG. 10a. The camera is monochrome, the illumination is color (R, G, B). The R, G, B illumination is pulsed with the pulse width less than the camera exposure time of each R, G, B illumination pulses. Each R, G, B exposure time is less than ⅓ pixel of constant y-motion scan.

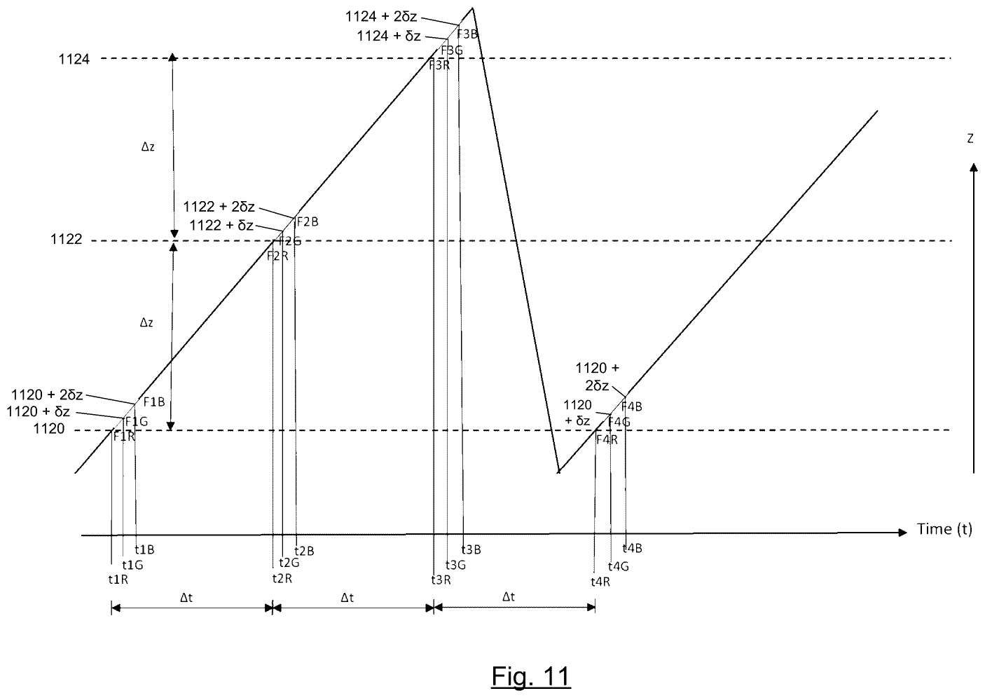

FIG. 11 is one more example of z-motion diagram to acquire three depth levels in a constant y-motion scan acquisition workflow using pulsed R, G, B illumination.

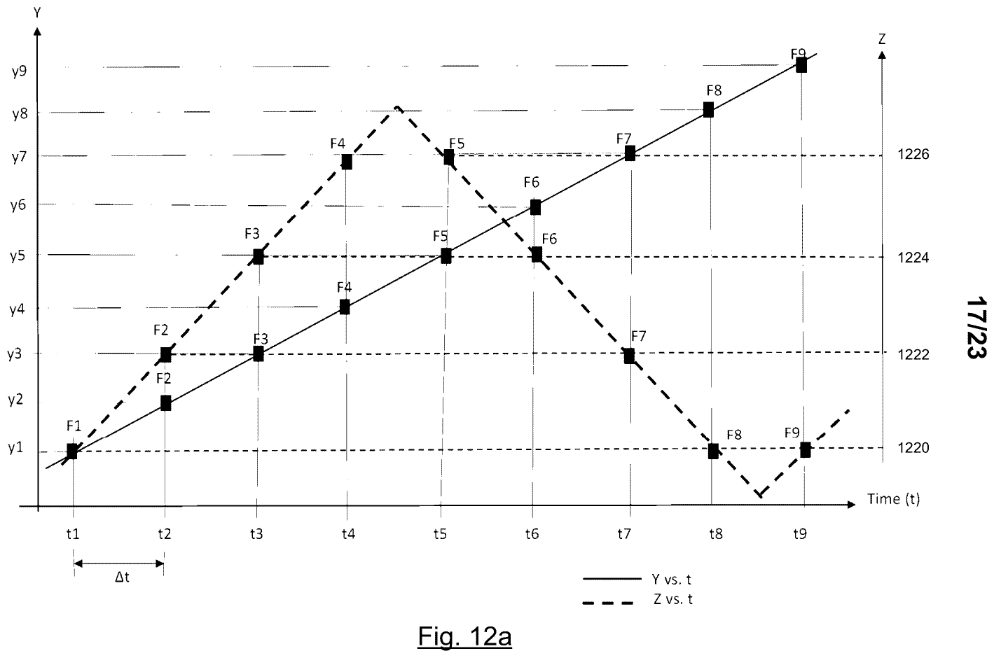

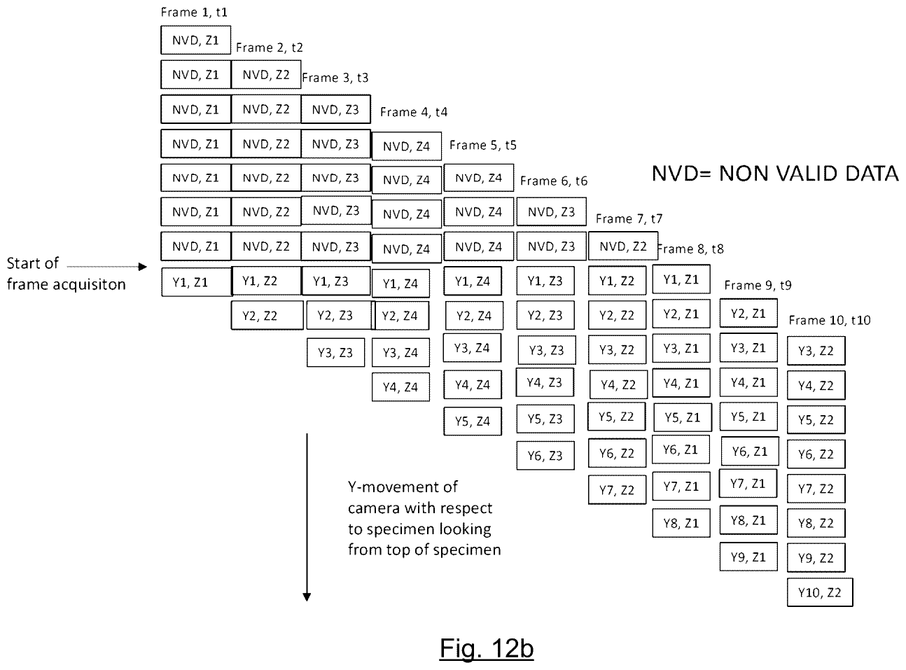

FIG. 12a is an example of 3D imaging showing a z-motion diagram to acquire four depth levels and MSIA 2 in a constant y-motion scan.

FIG. 12b is an example top view schematic diagram of constant y-motion where four depth (z-motion) levels of a specimen with MSIA 2 are captured in a single constant y-motion scan using a windowed color or monochrome area sensor array as described in the z-motion timing diagram of FIG. 12a. The illumination is white (RGB) or one-color R, G, B . . . , etc.

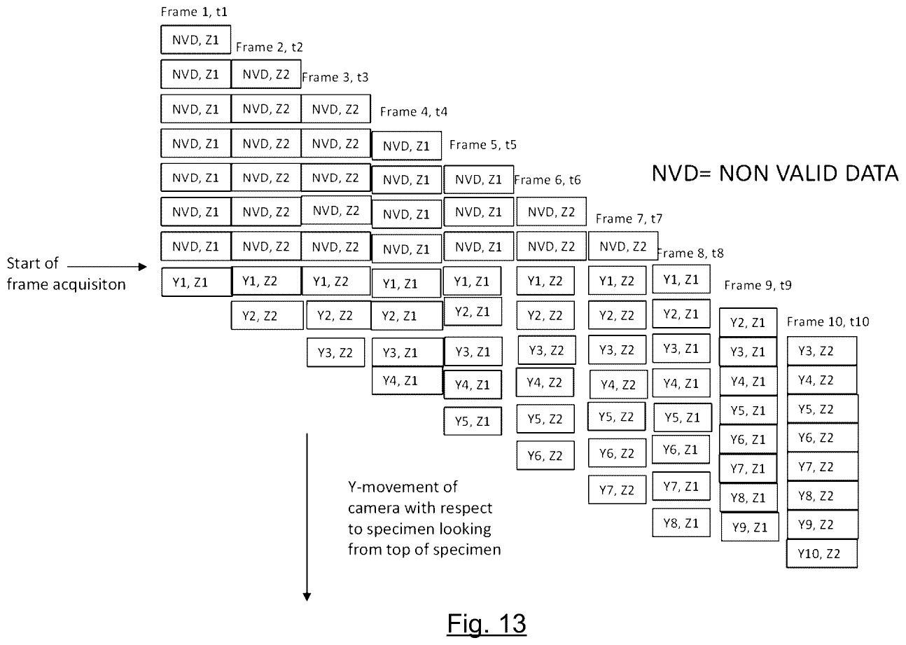

FIG. 13 is another example top view schematic diagram where two depth (z-motion) levels of a specimen with MSIA 4 are captured in a single constant y-motion scan using a windowed color or monochrome area sensor array.

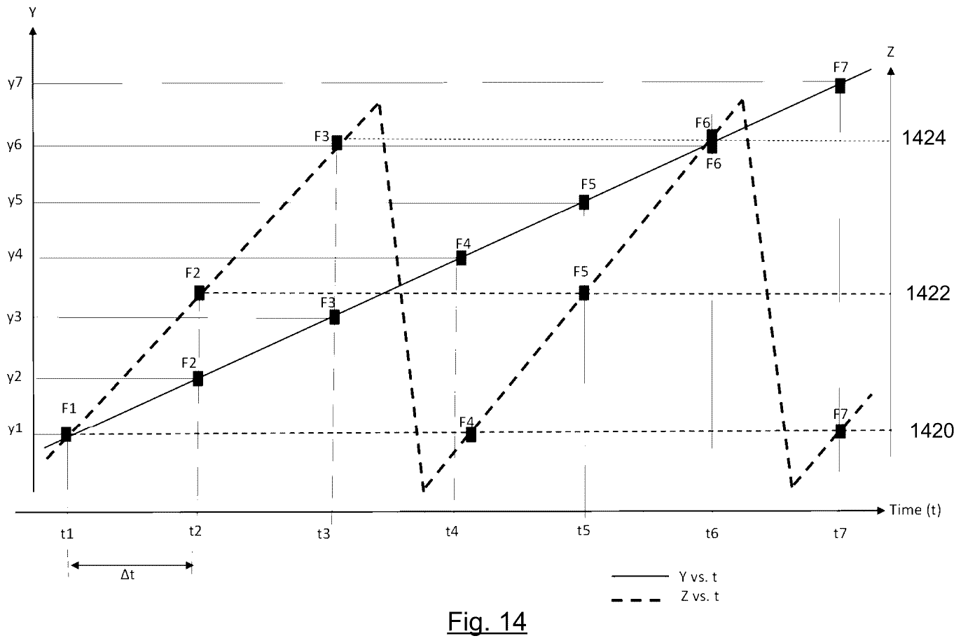

FIG. 14 is one more example of a schematic diagram where three depth (z-motion) levels of a specimen with MSIA 2 are captured in a single constant y-motion scan using a windowed monochrome area sensor array. The illumination is white RGB, one color R, G, B . . . , etc. and pulsed.

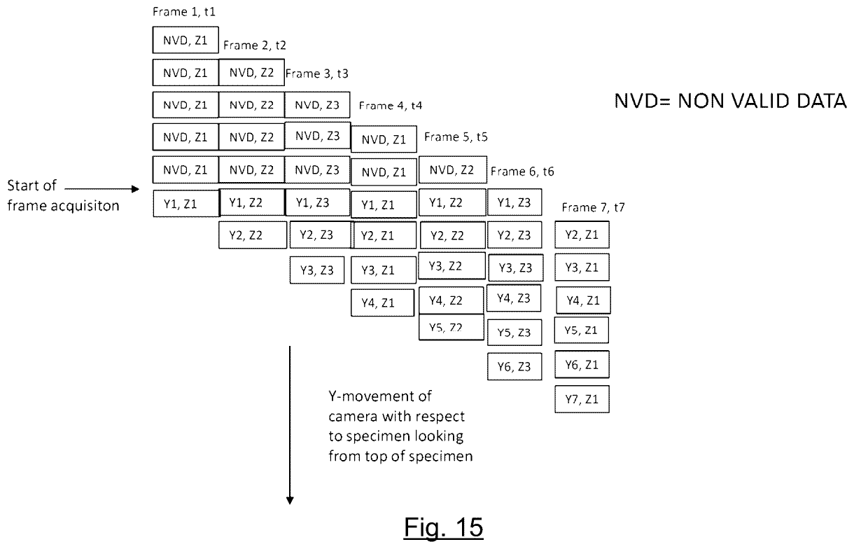

FIG. 15 is one more example top view schematic diagram where two depth (z-motion) levels of a specimen with MSIA 4 are captured in a single constant y-motion scan using a windowed monochrome area sensor array. The illumination is white (RGB), or one-color R, G, B, . . . , etc. continuous or pulsed.

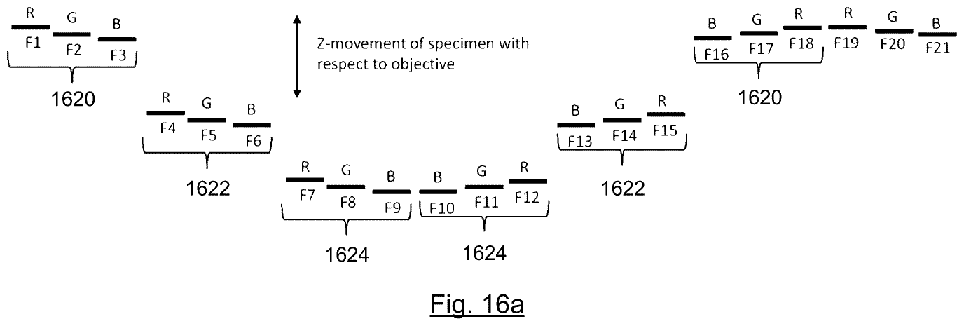

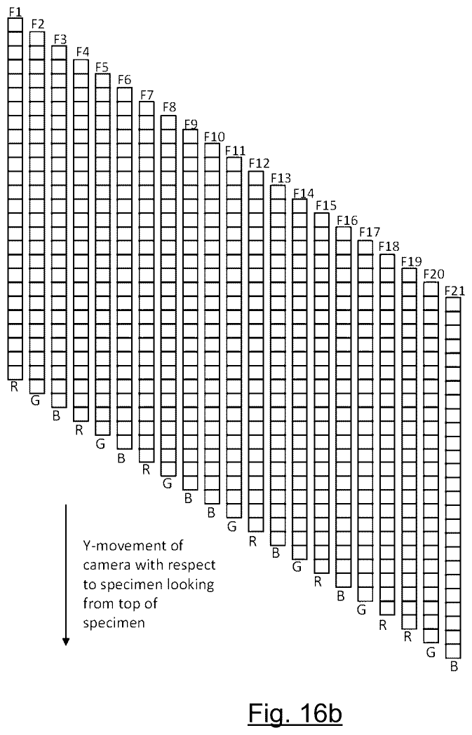

FIG. 16a is yet another example side view schematic diagram showing three depth (z-motion) levels of a specimen with MSIA 2 are captured in a single constant y-motion scan using a windowed monochrome area sensor array. The illumination is R, G, B or one-color R, G, B, . . . , etc. and pulsed.

FIG. 16b is a top view schematic diagram of example shown in FIG. 16a where three depth (z-motion) levels of a specimen with MSIA 2 are captured in a single constant y-motion scan using a windowed monochrome area sensor array. The illumination is R, G, B or one-color R, G, B, . . . , etc. and pulsed.

### DETAILED DESCRIPTION

Various systems, apparatus, compositions, and processes will be described below to provide an example of one or more embodiments. No embodiment described below limits any claimed embodiment and any claimed embodiment may cover systems, apparatus, compositions, or processes that differ from those described below. The claimed embodiments are not limited to systems, apparatus, compositions, or processes having all of the features of any one system, apparatus, composition or process described below or to features common to multiple or all of the systems, apparatus, compositions or processes described below. It is possible that a system, apparatus, composition, or process described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

### PRIOR ART

FIG. 1 illustrates a schematic view of a scanning brightfield microscope with computer-controlled stage and light source. A tissue specimen 100 (or other specimen to be imaged) may be mounted on microscope slide 101 and illuminated from below by illumination source 350, where the color, intensity, and on-time of the illumination source is controlled by computer 320 through connection 330 (or other communication mechanism such as Wi-Fi or Bluetooth). In some cases, the tissue specimen 100 may be a biological specimen, which is commonly covered with a transparent cover slip (not shown). Light passing through the specimen 100 is collected by infinity-corrected microscope objective 115 which is focused on the specimen by motorized positioner 120. Alternatively focus can be achieved by moving the motorized stage 105 away/towards the objective 115. The microscope objective 115 and tube lens 125 form a real image of the specimen on a monochrome area detector array 304, inside camera 305. An image of the specimen is collected by moving the specimen (and the microscope slide when the specimen is mounted on a microscope slide) at constant speed using motorized stage 105 (controlled by computer 320) through connection 340 (or other communication mechanism including Wi-Fi or Bluetooth) in a direction parallel to the columns of detector pixels of a monochrome detector array 304 in camera 305. The shutter in camera 305 (which may be part of detector array 304) is actuated by frame grabber 310, which is controlled by computer 320 through connection 315 (or other communication mechanism). Note that in some embodiments the frame grabber can sometimes be effectively absorbed into the computer or camera, such as in a GigE camera (these are commonly referred to as frame grabber-less systems). The shutter is open for only a short time for each exposure, for example, for the time it takes for the image projected onto the detector array by tube lens 125 to move a distance across the detector array that is less than or equal to half the distance between adjacent rows in the array. Alternatively, as with a rolling shutter sensor, pulsed illumination can be used to freeze the motion with a very short exposure time. The goal is to maintain the movement blur to less than a fraction of one pixel.

Computer 320 combines a sequence of contiguous area images from the array to construct an image of one strip across the specimen, as shown in FIG. 2a (red illumination channel shown). Strips are then assembled to form a complete image of the specimen. FIG. 2b shows the same strip 1 from FIG. 2a but in a simplified representation highlighting non-overlapping frames which will be useful when later comparing to MSIA (Moving Specimen Image Averaging) imaging.

Many industrial and scientific cameras use CMOS sensors with analog to digital converters (ADCs) at the end/edge of each column as shown in FIG. 3 and described, for example, in “High Performance Silicon Imaging-Fundamentals and Applications of CMOS and CCD Sensors, 2nd Edition”, Chapter 5.3.1, Daniel Durini-Editor, Woodhead Publishing. High speed CMOS sensors such as the one shown in FIG. 3 can be windowed down in the direction of the scan. Herein, the term “windowed” means that an active area of the sensor array that captures a frame of the image has been reduced to a smaller area. For example, a 4096-column×4096 row CMOS sensor that can achieve 100 frames per second can be windowed down to 2048 rows and achieve a little under 200 frames per second (there is typically some row overhead that ultimately limits the data throughput compared to its full-frame maximum). Therefore, both the full window and half-window cases have roughly the same data throughput=4096*4096 * 100=4096 * 2048*200=1.68 MPixels/s. Note that while windowing down in the direction of the scan (reducing number of rows) roughly conserves data throughput, windowing perpendicular to the direction of the scan (reducing the number of columns) does not. Therefore, the conventional scan direction in FIG. 1 is parallel to the columns in the CMOS sensor in order to take advantage of sensor windowing in the direction of the scan.

For brightfield imaging, most strip-scanning instruments illuminate the specimen from below and detect the image in transmission using a sensor placed above the specimen. In brightfield, signal strength is high, and red, green, and blue channels are often detected simultaneously using white-light illumination with an RGB sensor, or sequentially, using pulsed R, G, and B illumination with a monochrome sensor.

Compared to brightfield imaging, fluorescence signals can be thousands of times weaker, and notably some fluorophores have much weaker emission than others. Fluorescence microscopy is usually performed using illumination from the same side as detection (i.e., epi-illumination) so that the bright illumination light passing through the specimen does not enter the detector.

Several different optical combinations can be used for epi-fluorescence illumination-including illumination light that is injected into the microscope path between the microscope objective and the tube lens, using a dichroic beam splitter to reflect it down through the microscope objective and onto the specimen. In addition, a narrow wavelength band for the illumination light may typically be chosen to match the absorption peak of the fluorophore in use.

FIG. 4 shows a schematic view of a fluorescence or photoluminescence microscope slide scanner using a light source (continuous or pulsed) for epi-illumination that is synchronized with the motion of the scanning stage. A tissue specimen 100 (or other specimen to be imaged) mounted on microscope slide 101 is illuminated from above by illumination source 1200 and beamsplitter 1210, where the color, intensity and on-time of the illumination source is controlled by computer 320 through connection 1205 (or other communication mechanism including Wi-Fi or Bluetooth).

In some cases, the tissue specimen 100 may be a biological specimen, which is commonly stained with a fluorescent stain (including those containing quantum dots) and is commonly covered with a transparent cover slip (not shown). Light from the illumination source 1200 is reflected toward specimen 100 by beamsplitter 1210 and passes through microscope objective 115 to illuminate the area of the specimen being imaged.

Fluorescent light emitted from the specimen is collected by infinity-corrected microscope objective 115 which is focused on the specimen by motorized positioner 120, passes through beamsplitter 1210 and fluorescence emission filter 1220. Alternately the specimen can be moved into focus by moving the stage 105 away/towards the objective 115. Fluorescence emission filter 1220 is chosen to pass the fluorescence wavelengths emitted by a fluorophore (and/or other source of fluorescence) in the specimen. The microscope objective 115 and tube lens 125 form a real image of the specimen on an area detector array 304, inside camera 305. An image of the specimen is collected by moving the specimen at constant speed using motorized stage 105 (controlled by computer 320) through connection 340 (or other communication mechanism including Wi-Fi or Bluetooth) in a direction parallel to the columns of detector pixels of the detector array 304 in camera 305.

The shutter in camera 305 (which may be part of detector array 304) is actuated by frame grabber 310 in synchronism with the position of the moving stage, which is controlled by computer 320 through connection 340 (or other communication mechanism). The shutter is open for only a short time for each exposure, for example for the time it takes for the image projected onto the detector array by tube lens 125 to move a distance across the detector array that is less than the distance between adjacent rows in the array.

Computer 320 combines a sequence of contiguous frame images from the array to construct an image of one strip across the specimen. When the instrument is configured for MSIA imaging, each image pixel position is imaged more than once, and the pixel data is averaged (or added, for weak fluorophores). Strips are then assembled to form a complete fluorescence image of the specimen.

When there is more than one fluorophore in the specimen, multiple fluorophores can be imaged in a single scan by changing the color of the illumination from light source 1200 (setting the excitation wavelength for a particular fluorophore) and changing emission filter 1220 (setting the emission wavelength for that fluorophore); both changes can be made at the same time and synchronized with the scan. In some cases, a single beam splitter and emission filter combination may be used with multiple excitation wavelengths, enabling the imaging system to acquire multiple fluorophores merely by changing the color of the excitation source only. When the instrument is configured for MSIA imaging, each image pixel position for each fluorophore is imaged more than once, and the pixel data for each fluorophore is averaged (or added, for weak fluorophores).

### Embodiments

For illustration purposes, FIG. 5 shows an area sensor array 500 of p rows by m columns of pixels. The schematic of the sensor array 500 also shows a windowed-down active area 502 of k rows by m columns that is further subdivided into equal size windowed down areas 504 of q rows by m column pixels. Although the windowed down area 502 is shown to be symmetrically chosen about the p rows of the sensor array any other windowed down area of the sensor array 500 can be chosen. For the purpose of this description, m, p, k, and q are all positive integers.

FIG. 6a shows a three-dimensional (3D) view of an example of constant y-motion imaging where four depth (z-motion) levels of a specimen are captured in a single y-motion scan using a windowed area sensor array. For the purposes of illustrating the method of capturing different depths within a specimen a windowed area 602 of k rows by m columns of pixels of the sensor array area 500 shown in FIG. 5. At time t1 the windowed area 602 of k rows by m columns of pixels of the sensor array 500 (shown in FIG. 5) captures frame F1. Frame F1 represents an in-focus area of a specimen at a first depth level 620. Herein, the reference z1 is also used to represent frame F1 being captured at a first depth level 620. At time t2 when the windowed area 602 of k rows by m columns of pixels has moved a quarter of y-distance (i.e. a quarter of k pixels) along the y-axis, and the specimen relative to the objective lens is moved to second depth level 622, frame F2 is captured. Herein, the reference z2 is also used to represent frame F2 being captured at a second depth level 622. At time t3 when the windowed area of k rows by m columns has moved a further quarter of y-distance along the y-axis (i.e. a quarter of k pixels), and the specimen relative to the objective lens is moved to depth level 624, frame F3 is captured. Herein, the reference z3 is also used to represent frame F3 being captured at a third depth level 624. At time t4 when the windowed area 602 of k rows by m columns of pixels has moved a further quarter of y-distance along the y-axis (i.e. a quarter of k pixels), and the specimen relative to the objective lens is moved to depth level 626 frame F4 is captured. Herein, the reference z4 is also used to represent frame F4 being captured at a fourth depth level 626. Since the y-motion is at a constant speed, and distance between frames is equal, in this example, the relative trigger times t1, t2, t3, and t4 between acquisition frames F1, F2, F3, and F4 are equal. Frames F1, F2, F3, and F4 represent the same windowed color or monochrome array area 602 of k rows by m columns of pixels of the area sensor array 500 shown in FIG. 5.

Frames F1, F2, F3, and F4 include overlapping areas of the specimen represented by sensor window area q×m at different depth levels within the specimen. In this example, 4×(q×m)=k×m pixel area. Image processing algorithms can be used to assemble images at different depth levels of at least a portion of a specimen from the acquired frames. FIG. 6b shows the top view of FIG. 6a example of constant y-motion imaging where four depth (z-motion) levels of a specimen are captured in a single y-motion scan using a windowed color or monochrome array area 602. For illustration purposes the windowed color or monochrome array area 602 consists of 4000×24 lines of a 4000×4000 sensor array 500 as shown in FIG. 5. The intent is to use the simplified representation in FIG. 6b to illustrate a variety of z-motions to acquire specimen depth features from a single y-motion scan. For illustration purposes frame F4 is bolded. FIG. 6c shows a top view of the example of FIG. 6a of constant y-motion imaging where four depth (i.e. motion in direction of z axis as shown on FIG. 6a) levels 620, 622, 624 and 626 of a specimen are captured in a single y-motion scan using a windowed color or monochrome array area 602. For illustration purposes the acquired frames F1, F2, F3, and F4 are displaced laterally to show the four depth (z-motion) levels 620 (z1), 622 (z2), 624 (z3) and 626 (z4) of at least a portion of a specimen imaged during the acquisition process. Also, for illustration purposes the bolded row of sub-frames 605 starting with the bottom of frame F1 and continuing to the top of frame F4 represents the first complete three-dimensional 4000×6 image stack. In this example, and for illustration purposes, the overlapping area 607 of q×m pixels in frame F4 is bolded and displayed to the right as a two-dimensional sensor area 607 of q×m pixels. The combination of the two-motions (y and z) is an assembly of overlapping frames that when combined with the appropriate image processing algorithms results in four image strips at four different depth (z) levels 620, 622, 624 and 626. The acquisition method described in FIGS. 6a, 6b and 6c can be used with a color sensor or a mono sensor with white light or single channel illumination in brightfield, fluorescence, darkfield, and other imaging modes.

FIG. 7a is an example of z-motion timing diagram illustrating the acquisition of five depth levels, or z-levels, 720, 722, 724, 726, 728 of at least a portion of a specimen in a scan acquisition workflow as described in FIGS. 6a, 6b, and 6c. Imaging systems shown in FIG. 1 and FIG. 4 can be used to perform the example z-motion workflow acquisition in FIG. 7a. The z-motion in this example is a symmetric “triangular” waveform. FIG. 7a shows at least one full period (time t1 to time t6) of the triangular waveform. When the focal plane of the objective is at depth position z1 at time t1 the camera is triggered to acquire frame F1. Similarly frames F2, F3, F4, F5, F6, and F7 are acquired at times t2, t3, t4, t5, t6, and t7, respectively. As shown in FIG. 7a, the timing difference Δt between two sequential triggers to acquire frames is the same, so that time t2-time t1=time t3−time t2=time t4−time t3=time t5−time t4=time t6−time t5=time t7-time t6=Δt. FIG. 7a also shows five different z levels 720 (z1), 722 (z2), 724 (z3), 726 (z4), 728 (z5) acquired in a single period that are equidistant from each other so that each depth level is spaced apart from an adjacent depth level by a same distance (e.g. z2−z1=z3−z2=z4−z3=z5−z4=Δz). Additionally, in this example, sequentially acquired frames, for example F1 and F2, correspond to depth levels 720 and 724 respectively, frames F2 and F3 correspond to depth levels 724 and 728 respectively, frames F3 and F4 correspond to depth levels 728 and 726 respectively while frames F4 and F5 correspond to depth levels 726 and 722, respectively, so that there is no corresponding order between sequentially acquired frames and depth levels. Frames F1, F2, F3, F4, F5, F6, F7, . . . , etc. are acquired at points on the repeating “triangular” waveform when the motion in the z direction is at constant velocity.

In FIG. 7b an example of windowed down area 702 (ROI) of 4096×30 lines of a color or monochrome sensor array 500 as shown in FIG. 5. The camera is moving at a constant velocity along the y-axis. In this example, frames are acquired each time the camera moves a distance of six rows i.e., ⅕ of the 30 rows of the windowed-down area 702 of sensor array 500 as shown in FIG. 5. For illustration purposes the frames in FIG. 7b are displaced with respect to each other to show the correspondence between frames acquired and the specimen depth levels. In sequence Frame F1 is acquired at depth level 720, frame F2 is acquired at depth level 724, frame F3 is acquired at depth level 728, frame F4 is acquired at depth level 726, frame F5 is acquired at depth level 722 then the process repeats itself where Frame 6 corresponds to level 720. The first complete 4096×6 pixel image stack in the scan is available after the completion of the exposure of 722, and an additional 4096×6 pixel image stack is completed after every additional specimen motion in the Y direction. For illustration purposes the bolded row of sub-frames 705 starting with the bottom of frame F1 and continuing to the top of frame F5 represents the first complete 3D 4096×6 image stack. The bolded portion 707 of frame F6 (i.e., six rows) are shown to the right in an expanded form of 4096 pixels×6 rows. The overlapping 4096×6 rows is used to generate the five different depth level images of the specimen.

FIG. 7c is an example illustration of the timing between camera trigger, exposure time, and illumination to capture frames as described in FIGS. 7a, and 7b. In this example, illumination is ON and continues for the capture of all frames. On the falling edge of the camera trigger at time t1, the camera shutter (the shutter of the windowed-down sensor of 4096×30 pixels as shown in FIG. 7b) is opened with an exposure time that is less than the time it takes for the image of the specimen on the sensor to move the distance between adjacent rows of pixels on the sensor to capture frame F1. At t2, the falling edge of the next camera trigger the windowed down area 702 of the camera sensor array 500 as shown in FIG. 5 of 4096×30 pixels shown in FIG. 7b is exposed and frame F2 is captured. Similarly frames F3, F4, F5 and F6 are subsequently captured. The camera trigger time intervals are equal and the exposure time for each captured frame is the same. The timing diagram in FIG. 7c shows one period of motion as described in FIGS. 7a, and 7b frames F1, F2, F3, F4, F5, F6, F7, . . . , etc. are acquired at points on the repeating “triangular” waveform when the motion in the z direction is at constant velocity.

FIG. 7d is another example illustration of the timing between camera trigger, exposure time, and illumination to capture frames as described in FIGS. 7a, and 7b. In this example, illumination is turned on by the rising edge of the camera trigger signal and is turned off by the falling edge of the shutter control signal (which closes the shutter at the end of the exposure time). The exposure time is less than the time it takes the image of the specimen on the image sensor to move the distance between adjacent rows (lines) of pixels on the sensor. The time bandwidth of the illumination pulse is equal or greater than the camera exposure time to capture a frame. On the falling edge of camera trigger at time t1, the camera windowed down sensor of 4096×30 pixels shown in FIG. 7b exposure time is turned ON with an exposure time a fraction of one pixel row to capture frame F1. At time t2, the falling edge of the next camera trigger the windowed down camera sensor of 4096×30 pixels shown in FIG. 7b is exposed and frame F2 is captured. Similarly frames F3, F4, F5 and F6 are subsequently captured. The camera trigger time intervals are equal and the exposure time for each captured frame is the same. In this example at the falling edge of the camera trigger, the illumination pulse starts. The pulse width is long enough so that camera exposure time during frame F1 capture is taking place while the illumination pulse is ON. In this example, the illumination pulse is turned OFF before the next trigger starts. The illumination pulse width is the same for all frames and the pulse width timing is as described in the capture of frame F1 allowing captures of frames F2, F3, F4, F5, and F6 in sequence.

FIG. 7e is another example illustration of the timing between camera trigger, exposure time, and illumination to capture frames as described in FIGS. 7a and 7b. In this example, illumination is pulsed for the capture of every frame. The time width of the illumination pulse is less than the camera exposure time for each frame. On the falling edge of camera trigger at time t1, the camera windowed down sensor of 4096×30 pixels shown in FIG. 7b exposure time is turned ON with an exposure time a fraction of one pixel row to capture frame F1. At time t2, the falling edge of the next camera trigger the windowed down camera sensor of 4096×30 pixels shown in FIG. 7b is exposed and frame F2 is captured. Similarly frames F3, F4, F5 and F6 are subsequently captured. The camera trigger time intervals are equal and the exposure time for each captured frame is the same. In this example the illumination pulse starts after the exposure time of the camera sensor is turned ON. The pulse width is shorter than the camera exposure time during frame F1 capture as shown in FIG. 7e. The illumination pulse width is the same for all frames and the pulse width timing is as described in the capture of frame F1 allowing captures of frames F2, F3, F4, F5, and F6 in sequence.

FIG. 8a is an example of a yz-motion (i.e. motion in the y direction and the z direction of the axis shown in FIG. 8a) timing diagram illustrating the acquisition of an even number of depth levels of specimen planes. In this example, four depth levels 820, 822, 824 and 826 have been chosen in a scan acquisition workflow, as also described in FIGS. 6a, 6b, and 6c. Imaging systems shown in FIG. 1 and FIG. 4 can be used to perform the example z-motion workflow acquisition in FIG. 8a. The motion in the z direction in this example is a symmetric “triangular” waveform. FIG. 8a shows at least one full period (i.e. time t1 to time t5) of the triangular waveform. When the focal plane of the objective is at depth position 820 at time t1 the camera is triggered to acquire frame F1. Similarly frames F2, F3, F4, F5, and F6 are acquired at times t2, t3, t4, t5, and t6, respectively. As shown in FIG. 8a, the timing difference Δt between two sequential triggers to acquire frames is the same, so that time t2−time t1=time t3−time t2=time t4−time t3=time t5−time t4=time t6−time t5=Δt. FIG. 8a also shows four different depth levels 820 (z1), 822 (z2), 824 (z3) and 826 (z4) acquired in a single period that are equidistant from each other so that z2−z1=z3−z2=z4−z3=Δz. Additionally, in this example, sequentially acquired frames, for example F1 and F2, correspond to z-levels 820 and 824 respectively, frames F2, and F3 correspond to z-levels 824 and 826 respectively, frames F3 and F4 correspond to z-levels 626 and 622 respectively so that there is no corresponding order between sequentially acquired frames and depth levels. Frames F1, F2, F3, F4, F5, F6, . . . , etc. are acquired at points on the repeating “triangular” waveform when the motion along the z-axis is at constant velocity. In FIG. 8b an example of windowed down area (ROI) 802 of 4096×32 lines of a color or monochrome sensor array 500 as shown in FIG. 5 is shown. The camera is moving at a constant velocity along the y-axis. In this example, frames are acquired each time the camera moves a distance of eight rows i.e., one quarter of the 32 rows of the windowed-down area sensor array. For illustration purposes the frames in FIG. 8b are displaced with respect to each other to show the correspondence between frames acquired and the specimen depth levels. In sequence Frame F1 is acquired at depth level 820, frame F2 is acquired at depth level 824, frame F3 is acquired at depth level 826, frame F4 is acquired at depth level 822 then the process repeats itself where Frame 5 corresponds to depth level 820 . . . , etc. For illustration purposes the bolded row 805 of sub-frames starting with the bottom of frame F1 and continuing to the top of frame F4 represents the first complete three-dimensional 4096×8 image stack. The bolded portion 807 of frame F5 i.e., 8 rows are shown to the right in an expanded form of bolded portion 807 of 4096 pixels×8 rows. The overlapping 4096×8 rows is used to generate the four depth level images of the specimen. A similar combination of motion along the y-axis with smaller or larger even number of depth levels can be used to acquire depth levels within a specimen. The illumination methods of continuous, pulsed with pulse width greater than the camera exposure time, and pulsed with pulse width less than the camera exposure time as described in FIGS. 7c, 7d, and 7e, respectively, may also apply in this case.

FIG. 9a is an example of yz-motion timing diagram illustrating the acquisition of five depth levels 920, 922, 924, 926, 928 of at least a portion of a specimen in a scan acquisition workflow as described in FIGS. 6a, 6b, and 6c. Imaging systems shown in FIG. 1 and FIG. 4 can be used to perform the example motion in the yz direction workflow acquisition in FIG. 9a. The motion in the z direction in this example is an asymmetric “sawtooth” waveform. FIG. 9a shows at least one full period (i.e. time t1 to time t6) of the “sawtooth” waveform. When the focal plane of the objective is at depth position 920 at time t1 the camera is triggered to acquire frame F1. Similarly frames F2, F3, F4, F5, F6, and F7 are acquired at times t2, t3, t4, t5, t6, and t7, respectively. As shown in FIG. 9a, the timing difference Δt between two sequential triggers to acquire frames is the same, so that time t2−time t1=time t3−time t2=time t4−time t3=time t5−time t4=time t6−time t5=time t7−time t6=Δt. FIG. 9a also shows five different depth levels acquired in a single period 920 (z1), 922 (z2), 924 (z3), 926 (z4) and 928 (z5) that are equidistant from each other so that z2−z1=z3−z2=z4−z3=z5−z4=Δz. Additionally, in this example, sequentially acquired frames, for example F1 and F2, correspond to depth levels 920 and 922 respectively, frames F2, and F3 correspond to depth levels 922 and 924 respectively, frames F3 and F4 correspond to depth levels 924 and 926 respectively while frames F4 and F5 correspond to depth levels 926 and 928 respectively so that there is corresponding order between sequentially acquired frames and z-levels. Frames F1, F2, F3, F4, F5, F6, F7, . . . , etc. are acquired at points on the repeating “sawtooth” waveform when the motion in the z direction is at constant speed.

In FIG. 9b an example of windowed down area (ROI) 902 of 4096×30-lines of a color or monochrome sensor array 500 as shown in FIG. 5 is shown. The camera is moving at a constant velocity along the y-axis as shown in FIG. 9b. Frames are acquired each time the camera moves a distance of six rows i.e., ⅕ of the 30 rows of the windowed-down area 902 of sensor array 500 as shown in FIG. 5. For illustration purposes the frames in FIG. 9b are displaced with respect to each other to show the correspondence between frames acquired and the specimen depth levels. In sequence Frame F1 is acquired at depth level 920, frame F2 is acquired at depth level 922, frame F3 is acquired at depth level 924, frame F4 is acquired at depth level 926, frame F5 is acquired at depth level 928 then the process repeats itself where Frame 6 corresponds to depth level 920 . . . , etc. Also, for illustration purposes the bolded row of sub-frames 905 starting with the bottom of frame F1 and continuing to the top of frame F5 represents the first complete 3D 4096×6 image stack. The bolded portion 907 of frame F6 (i.e., six rows) are shown to the right in an expanded form of bolded portion 907 of 4096 pixels×6 rows. The vertical stack 4096×6 pixel subframes is used to generate the five depth level images of the specimen. Although in this example an odd number of depth levels is used an even number of depth levels is also possible. Also note that in the present application, the scan speed of the moving stage is held constant, but the shape of the waveform will be rounded at the top and bottom of the triangles as the focus motion direction is changed. A disadvantage of the sawtooth waveform shown in FIG. 9a is the rapid motion in the z direction that is required between exposure 5 and exposure 6, which may cause vibration that will limit the scan speed.

FIG. 10a is an example of z-motion timing diagram illustrating the acquisition of five depth levels 1020, 1022, 1024, 1026, and 1028 of at least a portion of a specimen in a scan acquisition workflow, as was described in FIGS. 6a, 6b, and 6c. Imaging systems shown in FIG. 1 and FIG. 4 can be used to perform the example motion in the z direction workflow acquisition in FIG. 10a. The motion in the z direction in this example is a symmetric “triangular” waveform. FIG. 10a shows at least one full period (i.e. time t1 to time t6) of the triangular waveform. In this example pulsed R, G, B illumination is used to acquire a brightfield image of a specimen in a single scan. When the focal plane of the objective is at depth position 1020 at time t1R the camera is triggered to acquire frame F1R, at time t1G the camera is triggered to acquire frame F1G, and at time t1B the camera is triggered to acquire frame F1B. The triggers of time t1R, time t1G, and time t1B are such that the acquired frames F1R, F1G, and F1B of the same portion of the specimen are within the depth of field (DOF) of the objective lens i.e., at depth level 1020. This means 2δz<DOF where δz is the distance in the z direction between two consecutive frames (e.g. F1R, F1G), (e.g. F1G, F1B) at depth level 1020. The distance the specimen moved along the y-axis during the capture of frames F1R, F1G, and F1B is a fraction of one pixel row so that the same portion of the specimen is captured at depth level 1020. Similarly at depth levels 1024, 1020+δz, 1020+2δz, frames F2R, F2G and F2B, respectively, are captured at trigger times t2R, t2G, and t2B, respectively, to represent the same portion of the specimen at depth level 1024. At depth levels 1028, 1028+δz, and 1028+2δz, frames F3R, F3G, F3B, respectively, are captured at trigger times t3R, t3G and t3B, respectively, to represent the same portion of the specimen at depth level 1028. At depth levels 1026, 1026+δz and 1026+2δz, frames F4R, F4G and F4B are captured, respectively, at trigger times t4R, t4G and t4B, respectively, to represent the same portion of the specimen at depth level 1026. At depth levels 1022, 1022+δz and 1022+2δz, frames F5R, F5G, F5B are captured, respectively, at trigger times t5R, t5G, t5B, respectively, to represent the same portion of the specimen at depth level 1022. At the completion of one period of travel in the z-direction, the process continues to capture the next portion of the specimen as shown in FIG. 10a where at depth levels 1020, 1020+δz and 1020+2δz, frames F6R, F6G and F6B are captured, respectively, at trigger times t6R, t6G and t6B, respectively, to represent the same portion of the specimen at depth level 1020. The continuous motion in the z-direction in synchronization with the constant velocity in the y direction continues until the entire RGB strip image of the specimen is captured in a single pass. In addition to brightfield, this imaging mode is applicable to other imaging modes such as fluorescence, darkfield . . . , etc.

FIG. 10b is an example illustration of the timing between camera trigger, exposure time, and illumination to capture frames as described in FIG. 10a. In this example, illumination is pulsed for the capture of all frames. The time bandwidth of the illumination pulse is equal or greater than the camera exposure time to capture a frame. On the falling edge of camera trigger at time t1R, the camera windowed down sensor is turned ON with an exposure time a fraction of one pixel row to capture frame F1R, where “one pixel row” means “the time it takes for the image on the sensor to move the distance from one row of pixels on the sensor to the next row. At time t1G, the falling edge of the next camera trigger the windowed down camera sensor is exposed and frame F1G is captured. At time t1B, the falling edge of the next camera trigger the windowed down area of the camera sensor is exposed and frame F1B is captured. Similarly frames F2R, F2G and F2B are subsequently captured at times t2R, t2G and t2B, respectively. Frames F3R, F3G and F3B are then captured at times t3R, t3G, and t3B, respectively, followed by frames F4R, F4G and F4B being captured at times t4R, t4G and t4B, respectively, and so on. The camera trigger time intervals are equal (i.e. time t2R−time t1R=time t3R−time t2R=time t4R−time t3R=time t2G−time t1G=time t3G−time t2G=time t4G−time t3G=time t2B−time t1B=time t3B−time t2B=time t4B−time t3B). The exposure time for each captured frame is the same. Additionally, the camera trigger time intervals are equal time (i.e. t1B−time t1G=time t1G-time t1R=time t2B−time t2G=time t2G−time t2R=time t3B−time t3G=time t3G−time t3R=time t4B−time t4G=time t4G−time t4R). In this example at the falling edge of the camera trigger, the illumination pulse starts. The pulse width is long enough so that camera exposure time during frame F1R capture is taking place while the red illumination pulse is ON. In this example, the red illumination pulse is turned OFF before the next trigger starts. The green illumination pulse is turned ON, at the falling edge the next trigger t1G the camera sensor exposure time is turned ON to capture frame F1G. The green illumination pulse is turned OFF. The blue illumination pulse is turned ON, at the falling edge the next trigger t1B the camera sensor exposure time is turned ON to capture frame F1B. In this example the illumination pulse width is the same for all frames and the pulse width timing is as described in the capture of frames F1R, F1G and F1B, allowing captures of frames F2R, F2G, F2B, F3R, F3G, F4R, F4G and F4B in sequence.

FIG. 10c is another example illustration of the timing between camera trigger, exposure time, and illumination to capture frames as described in FIG. 10a. In this example, illumination is pulsed for the capture of all frames. The time bandwidth of the illumination pulse is less than the camera exposure time to capture a frame. On the falling edge of camera trigger at time t1R, the camera windowed down sensor is turned ON to capture frame F1R. At time t1G, the falling edge of the next camera trigger the windowed down camera sensor is exposed and frame F1G is captured. Similarly frames F2R, F2G and F2B are subsequently captured at times t2R, t2G, and t2B, respectively. Frames F3R, F3G and F3B are then captured at times t3R, t3G, and t3B respectively, followed by frames F4R, F4G and F4B being captured at times t4R, t4G and t4B respectively, and so on. The camera trigger time intervals are equal (i.e. time t2R−time t1R=time t3R−time t2R=time t4R−time t3R=time t2G−time t1G=time t3G−time t2G=time t4G−time t3G=time t2B−time t1B=time t3B−time t2B=time t4B−time t3B. The exposure time for each captured frame is the same. Additionally, the camera trigger time intervals are equal (i.e. time t1B−time t1G=time t1G−time t1R=time t2B−time t2G=time t2G−time t2R=time t3B−time t3G=time t3G−time t3R=time t4B−time t4G=time t4G−time t4R. In this example after the camera exposure time is turned ON to capture frame F1R the red illumination pulse is turned ON a short time later with a pulse width less than the camera exposure time. The red illumination pulse is turned OFF before the camera exposure time is turned off. This ensures the red illumination pulse is inside the camera exposure time. The same timing process is used to capture frame F1G. At the falling edge of camera trigger time t1G the camera exposure time starts, a short time later the green illumination pulse is turned ON with a pulse width less than the camera exposure time. The green illumination pulse is turned OFF before the camera exposure time is turned off. This ensures the green illumination pulse is inside the camera exposure time. Similarly frame F1B is captured, at the falling edge of camera trigger time t1B the camera exposure time starts, a short time later the blue illumination pulse is turned ON with a pulse width less than the camera exposure time. The blue illumination pulse is turned OFF before the camera exposure time is turned off. This ensures the blue illumination pulse is inside the camera exposure time. At the completion of capturing frames F1R, F1G and F1B the specimen moved a fraction of one pixel row. In this example the illumination pulse width is the same for all frames and the pulse width timing is as described in the capture of frame F1R, F1G and F1B providing for captures of frames F2R, F2G, F2B, F3R, F3G, F4R, F4G and F4B in sequence.

FIG. 11 is another example of a z-motion timing diagram illustrating the acquisition of three depth levels 1120, 1122, and 1124 of at least a portion of a specimen in a scan acquisition workflow as described in FIGS. 6a, 6b, and 6c. Imaging systems shown in FIG. 1 and FIG. 4 can be used to perform the example z-motion workflow acquisition in FIG. 11. The motion in the z direction in this example is an asymmetric “sawtooth” waveform. FIG. 11 shows at least one full period (time t1 to time t4) of the asymmetric waveform. In this example, pulsed R, G, B illumination is used to acquire a brightfield image of a specimen in a single scan. When the focal plane of the objective is at depth level 1120 at time t1R the camera is triggered to acquire frame F1R, at time t1G the camera is triggered to acquire frame F1G, and at time t1B the camera is triggered to acquire frame F1B. The trigger times t1R, t1G, and t1B are such that the acquired frames F1R, F1G, and F1B, respectively, of the same portion of the specimen are within the depth of field (DOF) of the objective lens i.e., at depth level 1120. This means 2δz<DOF where δz is the distance travelled in the z direction between two consecutive frames (i.e. F1R, F1G), (i.e. F1G, F1B) at depth level 1120. The distance the specimen moved along the y-axis during the capture of frames F1R, F1G, and F1B is a fraction of one pixel row so that the same portion of the specimen is captured at level 1120. Similarly at depth levels 1122, 1122+δz and 1122+2δz, frames F2R, F2G and F2B, respectively, are captured at trigger times t2R, t2G and t2B, respectively, to represent the same portion of the specimen at depth level 1122. At depth levels 1124, 1124+δz and 1124+2δz, frames F3R, F3G and F3B are captured, respectively, at trigger times t3R, t3G and t3B, respectively, to represent the same portion of the specimen at depth level 1124. At the completion of one period of motion in the z direction, the process continues to capture the next portion of the specimen as shown in FIG. 11 where at depth levels 1120, 1120+δz and 1120+2δz, frames F4R, F4G and F4B are captured, respectively, at trigger times t4R, t4G and t4B, respectively, to represent the same portion of the specimen at depth level 1120. The continuous motion in the z direction in synchronization with the constant velocity in the y direction continues until the entire RGB strip image of the specimen is captured in a single pass. In addition to brightfield this imaging mode is applicable to other imaging modes such as fluorescence, darkfield . . . , etc.

FIG. 12a is an example of y- and z-motion timing diagram illustrating the acquisition of four depth levels 1220, 1222, 1224 and 1226 of at least a portion of a specimen in a scan acquisition workflow as described in FIGS. 6a, 6b, and 6c. with the addition of frame averaging using the Moving Specimen Intensity Average (MSIA) method. Imaging systems shown in FIG. 1 and FIG. 4 can be used to perform the example z-motion workflow acquisition in FIG. 12a. For illustration purposes the plot of y vs. t represented by the solid line shows a constant velocity motion of the specimen relative to the camera in the direction of the scan (the y direction). The plot of z vs. t is represented by a broken line showing a repeating triangular motion. For illustration purposes a numerical example is selected to demonstrate the method. In this example, four depth levels 1220, 1222, 1224 and 1226 of at least a portion of a specimen are acquired with the signal of each pixel of every depth level of the specimen averaged twice. A camera sensor of 4000×4000 pixels is windowed down to 4000×128 pixel.

At time t1 and depth level 1220, frame F1 is captured. At time t2 and depth level 1222 when the sensor moved by 16 rows relative to the objective frame, F2 is captured. At time t3, when the sensor moved by an additional 16 rows relative to the objective depth level and changed to depth level 1224, frame F3 was captured. At time t4, the sensor moved by an additional 16 rows relative to the objective and to the depth level 1226 and frame F4 was captured. In this example, since this is a triangular waveform z-motion after frame F4 is captured at time t4, the motion in the z-direction decelerates to a stop, then accelerates to a constant velocity where at time t5, frame F5 is captured. Since this is a symmetric z-axis motion, frame F5 at time t5 is captured at depth level 1226. Frame F5 is captured when the sensor has moved by additional 16 rows relative to the objective. At trigger time t6, 16 rows later, frame F6 is captured at depth level 1224. Similarly, frame F7 is captured at depth level 1222 and time t7, and frame F8 is captured at depth level 1220 and time t8. At the completion of one period of motion in the z direction, the same portion of a specimen of 4000×16-pixel rows is captured two times at all four depth levels 1220, 1222, 1224 and 1226. In a continuous movement in the y-direction and in the z-direction, at time t9 and depth level 1220, frame F9 is captured to image the next portion of the specimen until frames of the entire specimen are captured. The frames are processed in a computer to produce images of the entire three-dimensional specimen under investigation. The images produced can be a two-dimensional extended focus image of the specimen, individual z-slice images at each depth level of the specimen, and a three-dimensional image reconstruction of the specimen. The trigger times t1, t2, t3, t4, t5, t6, t7, t8, t9, t10, etc. take place at a constant time interval Δt.

FIG. 12b is a top view illustration of the example shown in FIG. 12a where the windowed down area (ROI) of 4000×128 line of a color or monochrome sensor array is shown. The camera is moving at a constant velocity along the y-axis. In this example, frames are acquired each time the camera moves a distance of 16 rows i.e., one eighth of the 128 rows of the windowed-down area sensor array. For illustration purposes, the frames in FIG. 12b are displaced with respect to each other to show the correspondence between frames acquired and the specimen depth levels 1220, 1222, 1224 and 1226. Also, for ease of illustration, the depth levels 1220, 1222, 1224 and 1226 are referred in FIGS. 12b as Z1, Z2, Z3 and Z4, respectively.

In sequence, at time t1, frame F1 is acquired at depth level 1220 (Z1), at time t2, frame F2 is acquired at depth level 1222 (Z2), at time t3, frame F3 is acquired at depth level 1224 (Z3), at time t4, frame F4 is acquired at depth level 1226 (Z4), at time t5, frame F5 is acquired at depth level 1226 (Z4), at time t6, frame F6 is acquired at depth level 1224 (Z3), at time t7, frame F7 is acquired at depth level 1222 (Z2), at time t8, frame F8 is acquired at depth level 1220 (Z1), the image acquisition process repeats itself where at time t9, frame F9 is acquired at depth level 1220 (Z1), at time t10, frame F10 is acquired at depth level 1222 (Z2) . . . , etc. Note that at time t8, when frame F8 is acquired, a first portion y1 of the specimen is acquired twice at all four depth levels 1220 (Z1), 1222 (Z2), 1224 (Z3) and 1226 (Z4). Note that at time t1, when the first frame F1 is acquired consisting of 4000×128-pixel rows only the first 16-pixel rows have valid data. At time t2, when frame F2 is acquired, the first 32-pixel rows have valid data so that frame F8 acquired at time t8 all 128-pixel rows have valid data. At time t9, when frame F9 is acquired the second portion y2 of the specimen is acquired twice at all four depth levels 1220 (Z1), 1222 (Z2), 1224 (Z3) and 1226 (Z4), at time t10 when frame F10 is acquired, a third portion y3 of the specimen is acquired twice at all four depth levels 1220 (Z1), 1222 (Z2), 1224 (Z3) and 1226 (Z4). The scan acquisition continues to capture the entire specimen. In this example, a combination of four depth levels 1220 (Z1), 1222 (Z2), 1224 (Z3) and 1226 (Z4) with MSIA is described and illustrated, however many other combinations of depth levels and MSIA are possible.

FIG. 13 is a top view illustration of another example of using a windowed down area of 4000×128-pixel rows of 4000×4000 pixels of a color or monochrome sensor array to acquire an image of a portion of a specimen at different depths with MSIA. In this example, the camera is moving at a constant velocity along the y-axis. In this example, frames are acquired each time the camera moves a distance of 16 rows (i.e., one eighth of the 128 rows of the windowed-down area sensor array). For illustration purposes, the frames in FIG. 13 are displaced with respect to each other to show the correspondence between frames acquired and the specimen depth levels. Also, for ease of illustration, the depth levels 1220 and 1222 are referred in FIGS. 13 as Z1 and Z2, respectively. Each acquired frame is 4000×128-pixel rows.

In sequence at time t1, Frame F1 is acquired at depth level 1220 (Z1), at time t2, 16 pixel rows later, frame F2 is acquired at depth level 1222 (Z2), at time t3 after an additional 16 pixel rows frame F3 is acquired at depth level 1222 (Z2), at time t4, after 16 additional rows frame F4 is acquired at depth level 1220 (Z1), at time t5, after 16 additional rows frame F5 is acquired at depth level 1220 (Z1), at time t6, after 16 additional rows frame F6 is acquired at depth level 1222 (Z2), at time t7 after 16 additional rows frame F7 is acquired at depth level 1222 (Z2), at time t8 after 16 additional rows frame F8 is acquired at depth level 1220 (Z1), the image acquisition process repeats itself where at time t9, frame F9 is acquired at depth level 1220 (Z1), at time t10 frame F10 is acquired at depth level 1222 (Z2) . . . , etc. Note that at time t8, when frame F8 is acquired, a first portion y1 of the specimen is acquired four times at two depth levels. Note that at time t1, when the first frame F1 is acquired consisting of 4000×128-pixel rows only the first 16-pixel rows have valid data. At time t2, when frame F2 is acquired the first 32-pixel rows have valid data so that, when frame F8 is acquired at time t8 all 128-pixel rows have valid data. At time t9, when frame F9 is acquired, the second portion y2 of the specimen is acquired four times at all two depth levels, at time t10 when frame F10 is acquired the third portion y3 of the specimen is acquired four times at two depth levels.

FIG. 14 is an example of y- and z-motion timing diagram illustrating the acquisition of three depth levels 1420, 1422 and 1424 of at least a portion of a specimen in a scan acquisition workflow as described in FIGS. 6a, 6b, and 6c. with the addition of frame averaging using the Moving Specimen Intensity Average (MSIA) method. Imaging systems shown in FIG. 1 and FIG. 4 can be used to perform the example z-motion workflow acquisition in FIG. 14. For illustration purposes the plot of y vs. t represented by the solid line shows a constant velocity motion of the specimen relative to the camera in the direction of the scan. The plot of z vs. t is represented by a broken line showing a repeating asymmetric sawtooth motion. For illustration purposes a numerical example is selected to demonstrate the method. In this example three depth levels 1420, 1422 and 1424 of at least a portion of a specimen are acquired with the signal of each pixel at every depth level of the specimen captured twice. A camera sensor of 4000×4000 pixels is windowed down to 4000×120 pixel. At time t1 and depth level 1420, frame F1 is captured. At time t2 and depth level 1422, when the sensor moved by 20 rows relative to the objective, frame F2 is captured. At time t3 and depth level 1424, when the sensor moved by additional 20 rows relative to the objective, frame F3 is captured. In this example since this is an asymmetric waveform, motion in the z-direction after frame F3 is captured at time t3 decelerates to a stop, then accelerates in the opposite direction followed by deceleration to a stop at the bottom of the motion. Motion then accelerates to a constant velocity where at time t4 when frame F4 is captured. Since this is a repeating z-axis motion, frame F4 is captured at time t4 at depth level 1420. Frame F5 is captured when the sensor moved by additional 20 rows relative to the objective. At trigger time t5, 20 rows later, frame F5 is captured at depth level 1422. At time t6, the sensor moves by 20 additional rows and frame F6 is captured at depth level 1424. At the completion of two periods of motion in the z-direction, the same portion of a specimen, of 4000×20-pixel rows, is captured two times at all three depth levels 1420, 1422 and 1424. In a continuous y-motion and z-motion process, at time t7 and at depth level 1420, frame F7 is captured to image the next portion of the specimen until frames of the entire specimen are captured. The frames are processed in a computer to produce images of the entire three-dimensional specimen under investigation. The images produced can be a two-dimensional extended focus image of the specimen, individual z-slice images at each depth level of the specimen, and a three-dimensional image reconstruction of the specimen. The trigger times t1, t2, t3, t4, t5, t6, t7, . . . , etc. happen at a constant time interval Δt.

FIG. 15 is a top view illustration of yet another example where the windowed down area (ROI) of 4000×120 line of a color or monochrome sensor array is shown. The camera is moving at a constant velocity along the y-axis. In this example, frames are acquired each time the camera moves a distance of 20 rows i.e., one sixth of the 120 rows of the windowed-down area sensor array. For illustration purposes the frames in FIG. 15 are displaced with respect to each other to show the correspondence between frames acquired and the specimen z-levels. Also, for ease of illustration, the depth levels 1420, 1422 and 1424 are referred in FIGS. 15 as Z1, Z2 and Z3, respectively.

In sequence at time t1, frame F1 is acquired at depth level 1420 (Z1), at time t2, frame F2 is acquired at depth level 1422 (Z2), at time t3, frame F3 is acquired at depth level 1424 (Z3), at time t4, frame F4 is acquired at depth level 1420 (Z1), at time t5, frame F5 is acquired at z-level depth level 1422 (Z2), at time t6, frame F6 is acquired at depth level 1424 (Z3). The image acquisition process repeats itself where at time t7, frame F7 is acquired at depth level 1420 (Z1), etc. Note that at time t6, when frame F6 is acquired, the first portion y1 of the specimen is acquired twice at all three depth levels 1420 (Z1), 1422 (Z2) and 1424 (Z3). Note that at time t1, when the first frame F1 is acquired consisting of 4000×120-pixel rows only the first 20-pixel rows have valid data. At time t2, when frame F2 is acquired the first 32-pixel rows have valid data so that frame F6 acquired at time t6, all 120-pixel rows have valid data. At time t7 when frame F7 is acquired the second portion y2 of the specimen is acquired twice at all three depth levels 1420 (Z1), 1422 (Z2) and 1424 (Z3). The scan acquisition continues to capture the entire specimen. In this example a combination of three z-levels with MSIA 2 is described and illustrated, however many other combinations of z-levels and MSIA are possible.

FIG. 16a is yet another example illustrating the acquisition of three depth levels 1620, 1622 and 1624 of at least a portion of a specimen in a scan acquisition workflow as described in FIGS. 6a, 6b, and 6c. with the addition of frame averaging using the Moving Specimen Intensity Average (MSIA) method and pulsed R, G, B illumination. Imaging systems shown in FIG. 1 and FIG. 4 can be used to perform the example z-motion workflow acquisition in FIG. 16a. In this side view illustration example, a windowed down area of 4000×576-pixel rows of a 4000×4000 pixels monochrome sensor array is used to acquire an image of a portion of a specimen at different depths with MSIA. The camera is moving at a constant velocity along the y-axis. In this example, frames are acquired each time the camera moves a distance of 32 rows i.e., one eighteenth of the 576 rows of the windowed-down area sensor array.

For illustration purposes the frames in FIG. 16a are displaced with respect to each other to show the correspondence between frames acquired and the specimen z-levels. Each acquired frame is 4000×576-pixel rows. In sequence, frame F1 is acquired during red illumination pulse, frame F2 is acquired during the green illumination pulse, F3 is acquired during blue illumination pulse. Frames F1, F2 and F3 are acquired at depth level 1620, which is the same as depth level 1020 as described in FIG. 10a, with a pulsing scheme illustrated in FIG. 10b or FIG. 10c. Similarly frames F4, F5, and F6 are acquired at a second depth level 1622 with pulsed illumination of R, G, and B, respectively. Frames F7, F8, and F9 are acquired at a third depth level 1624 with pulsed illumination of R, G, and B, respectively. The motion in the z-direction decelerates to a stop after frames F7, F8, and F9 are acquired and changes direction. The specimen accelerates upwards towards the objective and reaches a constant velocity at depth level 1624 at which point frames F10, F11, and F12 are acquired with pulsed illumination of B, G, and R, respectively. The specimen motion continues moving upwards towards the objective at constant velocity. When it reaches depth level 1622 frames F13, F14, and F15 are acquired at substantially the same depth level 1622 with pulsed illumination B, G, and R, respectively. Similarly, when the specimen reaches z-depth level 1620 frames F16, F17, and F18 are acquired with pulsed illumination B, G, and R, respectively. After frame F18 is acquired at depth level 1620, the motion of the specimen towards the objective decelerates to a stop, and changes direction. At this point one period of motion is completed where three depth levels 1620, 1622 and 1624 of the same portion of the specimen are acquired twice. The specimen accelerates downwards towards the objective it reaches a constant velocity at depth level 1620 at which point frames F19, F20, and F21 are acquired at substantially the same depth level 1620 with pulsed illumination of R, G, and B, respectively. The z-axis periodic motion of the specimen relative to the objective continues to capture the remaining portions of the specimen at three depth levels.

FIG. 16b is a top view illustration of the example shown in FIG. 16a where the windowed down area (ROI) of 4000×576 lines of a 4000×4000 color or monochrome sensor array is shown. The camera is moving at a constant velocity along the y-axis. For illustration purposes the frames in FIG. 16b are displaced with respect to each other to show the correspondence between frames acquired and the specimen depth levels. In this example, frames F1, F2, and F3 are acquired at substantially the same time by running the camera at three times the speed compared to the examples described in FIGS. 12a, 12b, 13, 14a, and 14b so that F1, F2, and F3 are acquired at substantially the same y position (i.e. <1 pixel line motion), and depth level (i.e. <1 DOF) of the objective. Each frame is acquired every 32 rows (i.e. one eighteenth of the 576 rows of the windowed-down area sensor array). Similarly, and in sequence, frames F4, F5, F6, F7, F8, F9, F10, F11, F12, F13, F14, F15, F16, F17, and F18 are acquired. Once frame F18 is acquired, the first portion of the specimen consisting of 32-pixel rows is acquired twice at each of the three depth levels 1620, 1622, and 1624 (i.e., MSIA 2). The y-motion on the specimen continues with acquisition of the remaining portions of the specimen at three depth levels with MSIA 2.

Table 1 below shows a number of example depth level-MSIA combinations when the number of pixel rows k selected is an even number.

TABLE 1
Example z-level - MSIA combinations when the number
of pixel rows k selected is an even number.

| | | | No. of depth levels | | Z-levels/MSIA |
|---|---|---|---|---|---|
| k | n | q | (z-levels) | MSIA | combinations |
| 2 | 2 | 1 | 2 | 0 | 1 |
| 4 | 4 | 1 | 4 | 0 | 2 |
| 4 | 2 | 2 | 2 | 2 | |
| 6 | 6 | 1 | 6 | 0 | 3 |
| 6 | 3 | 2 | 3 | 2 | |
| 6 | 2 | 3 | 2 | 3 | |
| 8 | 8 | 1 | 8 | 0 | 3 |
| 8 | 4 | 2 | 4 | 2 | |
| 8 | 2 | 4 | 2 | 4 | |
| . . . | . . . | . . . | . . . | . . . | . . . |
| 512 | 512 | 1 | 512 | 0 | 9 |
| 512 | 256 | 2 | 256 | 2 | |
| 512 | 128 | 4 | 128 | 4 | |
| 512 | 64 | 8 | 64 | 8 | |
| 512 | 32 | 16 | 32 | 16 | |
| 512 | 16 | 32 | 16 | 32 | |
| 512 | 8 | 64 | 8 | 64 | |
| 512 | 4 | 128 | 4 | 128 | |
| 512 | 2 | 256 | 2 | 256 | |

Table 2 below shows a number of example depth level-MSIA combinations when the number of pixel rows k selected is an odd number.

TABLE 2
Example depth-level - MSIA combinations when the
number of pixel rows k selected is an odd number.

| | | | No. of | | Z-levels - |
|---|---|---|---|---|---|
| k | n | q | depth levels | MSIA | MSIA combinations |
| 3 | 3 | 1 | 3 | 0 | 1 |
| 5 | 5 | 1 | 5 | 0 | 1 |
| 7 | 7 | 1 | 7 | 1 | 1 |
| 9 | 9 | 1 | 9 | 0 | 2 |
| 9 | 3 | 3 | 3 | 3 | |
| 11 | 11 | 11 | 11 | 1 | 1 |
| 13 | 13 | 1 | 13 | 0 | 1 |
| 15 | 15 | 1 | 15 | 0 | 3 |
| 15 | 5 | 3 | 5 | 3 | |
| 15 | 3 | 5 | 3 | 5 | |
| . . . | . . . | . . . | . . . | . . . | . . . |
| 501 | 501 | 1 | 501 | 0 | 3 |
| 501 | 167 | 3 | 167 | 3 | |
| 501 | 3 | 167 | 3 | 167 | |
| 503 | 503 | 1 | 503 | 0 | 1 |

The tables above show a large number of depth-level-MSIA combinations except when k is a prime number MSIA is not possible. From the practical point of view, the number of depth levels will depend on the thickness of the specimen, the transparency of the specimen, the wavelength of the illumination used, and the image mode (e.g. brightfield, fluorescence).

With distortion correction the entire sensor array can be used to acquire depth level images with MSIA.

### Definitions

For the purposes of this document, a “specimen” is generally defined as a portion or quantity of material, such as a biological material or a tissue, for use in testing, examination or study. “Specimen” may include “macroscopic specimens” that are considered to be specimens that are larger than the field of view of a compound optical microscope, such as a compound optical microscope containing a microscope objective that has the same Numerical Aperture (NA) as that of the scanner described in this document.

For the purposes of this document the term “image acquisition” generally includes the steps necessary to acquire and produce a final image of the specimen, which may include some of, but is not necessarily limited to, the following: the steps of preview scanning, instrument focus, predicting and setting gain for imaging each fluorophore, image adjustments including demosaicing (where required), scan linearity adjustment, field flattening (compensating for fluorescence intensity variation caused by excitation intensity and detection sensitivity changes across the field of view), dark frame subtraction, correction of frame images for geometric distortion, correction of fluorescence signal in one channel caused by overlap of fluorescence from adjacent (in wavelength) channels when two or more fluorophores are excited simultaneously, dynamic range adjustment, butting or stitching together adjacent image strips (when necessary), storing, transmitting, assembling and viewing the final image.

Moving Specimen Image Averaging (“MSIA”) is generally defined as the method and technology for acquiring digital strip images (i.e., image strips) across a large microscope specimen or other specimen by capturing sequential overlapping frame images of a moving specimen, typically where a new image frame is captured each time the specimen has moved a distance that causes the image of that specimen projected by the optics onto a two-dimensional detector array to move a distance equal to the distance between a small number of predetermined rows of detectors in the detector array (where this number is normally held constant while scanning digital image strips), image data from the new frame is translated (moved) in computer memory to match the motion of the optical image across the detector array, and is added to (or in some cases may be averaged with) the data previously stored to generate an image of a strip across the specimen. In some cases, such a procedure may be continued until the specimen has moved a distance such that all object points in that strip have been exposed a number of times equal to the number of active rows in the detector array (usually chosen by defining a “detector area of interest” or “detector active area” that has the width of the detector but a smaller number of rows than the detector array contains) divided by the smaller number of rows moved between each successive image capture. All pixels in the image strip that results tend to have increased signal-to-noise ratio (S/N) because of pixel averaging, where the increased signal-to-noise ratio is equal to the square root of the number of times each pixel has been averaged to produce the final MSIA strip image, and increased dynamic range because of pixel addition and the reduction of noise caused by averaging (especially in the dark pixels).

As used herein, the terms “frame image” and “image frame” are identical to one another and are used interchangeably.

“Z-stack slices” is an image acquisition method where multiple images are taken at different focal distances within a specimen. The method is generally used to capture features of thick specimens.

“3D volume image” is a representation of a specimen as a function of three spatial coordinates (x, y, z). In a digital volume image, each sample (voxel) represents this quantity measured at a specific (x, y, z) location. The image is made by a spatial sequence of 2D slices of the specimen.

“Extended focus image” is a composite image with a greater depth of field (e.g., the thickness of the plane of focus) than any of the individual source image from a sequence of images, called an “image stack.”

“Fluorescence” includes fluorescence from naturally occurring sources inside the specimen and fluorescent dyes and markers (including for example quantum dots) that may be added to the specimen, as well as fluorescence from the substrate or a layer above the specimen.

“Spectral imaging” refers to the method and technology for acquiring images in which each pixel is represented by its wavelength spectrum.

“Hyperspectral imaging” refers to the method and technology for acquiring images in which each pixel is represented by a spectrum composed of narrow spectral bands over a continuous spectral range.

“Imaging spectroscopy” refers to the acquisition and processing of hyperspectral images.

“Multispectral imaging” refers to the method and technology for acquiring multiple images of an object, each image representing a range of wavelengths. For example, each image could represent the emission range (or part of the emission range) of a particular fluorophore. In this case each pixel in the final multispectral image may not contain a spectrum of the fluorescence emitted by the specimen at that position but contains information about the signal detected from each fluorophore at that pixel position.

The “scan plane” is defined as a plane in which the specimen moves during scanning. When the specimen is mounted on a microscope slide, the scan plane is typically parallel to the surface of the microscope slide.

Herein, the term “windowed down” means that an active area of the sensor array that captures a frame of the image has been reduced to a smaller area than an area od the sensor array itself. Herein, if a sensor array of p pixel rows and m pixel columns is “windowed down” to k pixel rows and m pixel columns, as described in FIG. 5, k is a positive integer and 2≤k≤p. The k pixel rows can be divided to q rows of sensor pixels so that k=nq where q is a positive integer and 1≤q≤k while n is a positive integer and 2≤n≤k. In general, two-dimensional sensor arrays have hundreds to thousands of pixel rows and pixel columns. If k=2 to satisfy the k=nq, and since n must be 2 then q=1.

One or more embodiments as described herein may provide a scanning instrument and method of brightfield imaging whereby a monochrome (greyscale) area detector array is used with a pulsed illumination source providing sequential R, G and B illumination where the pulsing of the illumination source is synchronized with the motion of a specimen on a computer-controlled scanning stage.

### Summary of Significant Characteristics of Various Embodiments

It should be understood that all embodiments noted below assume a constant velocity of the stage in the y-motion.

TABLE 3
Significant Characteristics of Various Embodiments

| Embodiment | 2D Camera | z-motion | Illumination | Image Mode | MSIA |
|---|---|---|---|---|---|
| 1 | color | Repeating | White lamp, white | Brightfield | No |
| | | symmetric | LED, combined RGB | (“BF”) | |
| | | e.g., | LED colors or | | |
| | | triangular | equivalent | | |
| | | | continuous | | |
| 2 | color | Repeating | White lamp, white | BF | No |
| | | asymmetric | LED, combined RGB | | |
| | | e.g., | LED colors or | | |
| | | sawtooth | equivalent | | |
| | | | continuous | | |
| 3 | color | Repeating | White lamp, white | BF | No |
| | | symmetric | LED, combined RGB | | |
| | | e.g., | LED colors or | | |
| | | triangular | equivalent | | |
| | | | pulsed | | |
| 4 | color | Repeating | White lamp, white | BF | No |
| | | asymmetric | LED, combined RGB | | |
| | | e.g., | LED colors or | | |
| | | sawtooth | equivalent | | |
| | | | pulsed | | |
| 5 | color | Repeating | White bulb, white | BF | yes |
| | | symmetric | LED, combined RGB | | |
| | | e.g., | LED colors or | | |
| | | triangular | equivalent | | |
| | | | continuous | | |
| 6 | color | Repeating | White lamp, white | BF | yes |
| | | asymmetric | LED, combined RGB | | |
| | | e.g., saw | LED colors or | | |
| | | tooth | equivalent | | |
| | | | continuous | | |
| 7 | color | Repeating | White lamp, white | BF | yes |
| | | symmetric | LED, combined RGB | | |
| | | e.g., | LED colors or | | |
| | | triangular | equivalent | | |
| | | | pulsed | | |
| 8 | color | Repeating | White lamp, white | BF | yes |
| | | asymmetric | LED, combined RGB | | |
| | | e.g., | LED colors or | | |
| | | sawtooth | equivalent | | |
| | | | pulsed | | |
| 9 | mono | Repeating | R, G, B LED or | BF | no |
| | | symmetric | equivalent pulsed | | |
| | | e.g., | | | |
| | | triangular | | | |
| 10 | mono | Repeating | R, G, B LED or | BF | no |
| | | asymmetric | equivalent pulsed | | |
| | | e.g., | | | |
| | | sawtooth | | | |
| 11 | mono | Repeating | R, G, B LED or | BF | yes |
| | | symmetric | equivalent pulsed | | |
| | | e.g., | | | |
| | | triangular | | | |
| 12 | mono | Repeating | R, G, B LED or | BF | yes |
| | | asymmetric | equivalent pulsed | | |
| | | e.g., | | | |
| | | sawtooth | | | |
| 13 | mono | Repeating | Single color, multiple | Fluorescence | No |
| | | symmetric | colors sequential, | (“FL”) | |
| | | e.g., | Continuous | | |
| | | triangular | | | |
| 14 | mono | Repeating | Single color, multiple | FL | yes |
| | | symmetric | colors, sequential | | |
| | | e.g., | Continuous | | |
| | | triangular | | | |
| 15 | mono | Repeating | Single color, multiple | FL | No |
| | | symmetric | colors, sequential | | |
| | | e.g., | pulsed | | |
| | | triangular | | | |
| 16 | mono | Repeating | Single color, multiple | FL | yes |
| | | symmetric | colors, sequential | | |
| | | e.g., | pulsed | | |
| | | triangular | | | |
| 17 | mono | Repeating | Single color, multiple | FL | no |
| | | asymmetric | colors, sequential | | |
| | | e.g., | continuous | | |
| | | sawtooth | | | |
| 18 | mono | Repeating | Single color, multiple | FL | yes |
| | | asymmetric | colors, sequential | | |
| | | e.g., | pulsed | | |
| | | sawtooth | | | |
| 19 | mono | Repeating | Single color, multiple | FL | No |
| | | asymmetric | colors sequential, | | |
| | | e.g., | Continuous | | |
| | | sawtooth | | | |
| 20 | mono | Repeating | Single color, multiple | FL | yes |
| | | asymmetric | colors, sequential | | |
| | | e.g., | Continuous | | |
| | | sawtooth | | | |
| 21 | mono | Repeating | Single color, multiple | FL | No |
| | | asymmetric | colors, sequential | | |
| | | e.g., | pulsed | | |
| | | sawtooth | | | |
| 22 | mono | Repeating | Single color, multiple | FL | yes |
| | | asymmetric | colors, sequential | | |
| | | e.g., | pulsed | | |
| | | sawtooth | | | |
| 23 | Color (BF, k = | | | BF | yes |
| | p), distortion | | | | |
| | corrected | | | | |
| | array) | | | | |
| 24 | Mono (BF, k = | | Single color, multiple | FL | yes |
| | p), distortion | | colors, sequential | | |
| | corrected | | pulsed | | |
| | array) | | | | |
| 25 | mono | | | Spectral, | yes |
| | | | | Multispectral, | |
| | | | | Spectroscopy, | |
| | | | | Hyperspectral | |

One or more embodiments as described herein may provide a scanning instrument and method of brightfield imaging whereby a synchronized motion (y-axis) of the specimen relative to a color p×m 2D array camera where p is the number of rows and m are the number columns in the array, and to the objective of the optical system (z-axis) under constant brightfield illumination to acquire several depth planes of a specimen and assemble them into a brightfield 3D volume image, and/or a 2D extended focus image, and/or z-stack image slices of the specimen in a single scan. In some embodiments, the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of a white lamp light source or an LED RGB light source.

One or more embodiments as described herein may provide a scanning instrument and method of brightfield imaging whereby a synchronized motion (y-axis) of the specimen relative to a color p×m 2D array camera where p is the number of rows and m are the number columns in the array, and to the objective of the optical system (z-axis) under constant brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of a white light source or an LED RGB light source.

One or more embodiments as described herein may provide a scanning instrument and method of brightfield imaging whereby a synchronized motion (y-axis) of the specimen relative to a color p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of a white light source or an LED RGB light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging whereby a synchronized motion (y-axis) of the specimen relative to a color p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of a white light source or an LED RGB light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging using MSIA whereby a synchronized motion (y-axis) of the specimen relative to a color p×m 2D array camera where p is the number of rows and m are the number columns in the array, and to the objective of the optical system (z-axis) under continuous brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of a white lamp light source or an LED RGB light source.

One or more embodiments as described herein may provide a scanning instrument and method of brightfield imaging using MSIA whereby a synchronized motion (y-axis) of the specimen relative to a color p×m 2D array camera where p is the number of rows and m are the number columns in the array, and to the objective of the optical system (z-axis) under continuous brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of a white lamp light source or an LED RGB light source.

One or more embodiments as described herein may provide a scanning instrument and method of brightfield imaging using MSIA whereby a synchronized motion (y-axis) of the specimen relative to a color p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of a white light source or an LED RGB light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging using MSIA whereby a synchronized motion (y-axis) of the specimen relative to a color p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of a white light source or an LED RGB light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging whereby a synchronized motion (y-axis) of the specimen relative to a monochrome p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of an R, G, B LED, or an equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging whereby a synchronized motion (y-axis) of the specimen relative to a monochrome p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of an R, G, B LED, or an equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging using MSIA whereby a synchronized motion (y-axis) of the specimen relative to a monochrome p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments brightfield illumination consisting of an R, G, B LED, or an equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging using MSIA whereby a synchronized motion (y-axis) of the specimen relative to a monochrome p×m 2D array camera where p is the number of rows and m are the number columns in the array, and to the objective of the optical system (z-axis) under pulsed brightfield illumination to acquire several depth planes of a specimen and assemble them into a brightfield 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments brightfield illumination consisting of an R, G, B LED, or an equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of fluorescence imaging whereby a synchronized motion (y-axis) of the specimen relative to a monochrome p×m 2D array camera where p is the number of rows and m are the number columns in the array, and to the objective of the optical system (z-axis) under constant fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments fluorescence illumination consists of multiple color LED or equivalent light source.

One or more embodiments as described herein may provide a scanning instrument and method of fluorescence imaging using MSIA whereby a synchronized motion (y-axis) of the specimen relative to a monochrome p×m 2D array camera where p is the number of rows and m are the number columns in the array, and to the objective of the optical system (z-axis) under constant fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments fluorescence illumination consists of an R, G, B LED, or an equivalent light source.

One or more embodiments as described herein may provide a scanning instrument and method of fluorescence imaging whereby a synchronized motion (y-axis) of the specimen relative to a monochrome p×m 2D array camera where p is the number of rows and m are the number columns in the array, and to the objective of the optical system (z-axis) under pulsed fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments fluorescence illumination consists of multiple color LED or equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of fluorescence imaging using MSIA whereby a synchronized motion (y-axis) of the specimen relative to a monochrome p×m 2D array camera where p is the number of rows and m are the number columns in the array, and to the objective of the optical system (z-axis) under pulsed fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating symmetric motion e.g., triangular waveform. Also, in some embodiments fluorescence illumination consists of multiple color LED or equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of fluorescence imaging whereby a synchronized motion (y-axis) of the specimen relative to a monochrome p×m 2D array camera where p is the number of rows and m are the number columns in the array, and to the objective of the optical system (z-axis) under constant fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments fluorescence illumination consists of multiple color LED or equivalent light source.

One or more embodiments as described herein may provide a scanning instrument and method of fluorescence imaging using MSIA whereby a synchronized motion (y-axis) of the specimen relative to a monochrome p×m 2D array camera where p is the number of rows and m are the number columns in the array, and to the objective of the optical system (z-axis) under constant fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments fluorescence illumination consists of an R, G, B LED, or an equivalent light source.

One or more embodiments as described herein may provide a scanning instrument and method of fluorescence imaging whereby a synchronized motion (y-axis) of the specimen relative to a monochrome p×m 2D array camera where p is the number of rows and m are the number columns in the array, and to the objective of the optical system (z-axis) under pulsed fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments fluorescence illumination consists of multiple color LED or equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of fluorescence imaging using MSIA whereby a synchronized motion (y-axis) of the specimen relative to a monochrome p×m 2D array camera where p is the number of rows and m are the number columns in the array, and to the objective of the optical system (z-axis) under pulsed fluorescence illumination to acquire several depth planes of a specimen and assemble them into a fluorescence 3D volume image, and/or a 2D extended focus image, and/or z-stack image slices of the specimen in a single scan. In some embodiments the 2D array camera is windowed down to k×m where k is the number of windowed-down rows in the array. In some other embodiments, the z-axis motion consists of a repeating asymmetric motion e.g., sawtooth waveform. Also, in some embodiments fluorescence illumination consists of multiple color LED or equivalent light source. In some embodiments the illumination pulse width can be greater than the exposure time of the 2D array camera while in some other embodiments can be less than the exposure time of the 2D array camera.

One or more embodiments as described herein may provide a scanning instrument and method of brightfield imaging using MSIA whereby a synchronized motion (y-axis) of the specimen relative to a color p×m 2D array camera where p is the number of rows and m are the number columns in the array, and to the objective of the optical system (z-axis) under continuous or pulsed illumination to acquire several depth planes of a specimen and assemble them into a brightfield 3D volume image, and/or a 2D extended focus image, and/or z-stack image slices of the specimen in a single scan. In some embodiments distortion correction is applied to the 2D array camera so that k=p and the whole p×m 2D array is used.

One or more embodiments as described herein may provide a scanning instrument and method of fluorescence imaging using MSIA whereby a synchronized motion (y-axis) of the specimen relative to a monochrome p×m 2D array camera where p is the number of rows and m are the number columns in the array, and to the objective of the optical system (z-axis) under continuous or pulsed illumination to acquire several depth planes of a specimen and assemble them into a fluorescence 3D volume image, and/or a 2D extended focus image, and/or z-stack image slices of the specimen in a single scan. In some embodiments distortion correction is applied to the 2D array camera so that k=p and the whole p×m 2D array camera is used.

One or more embodiments as described herein may provide a scanning instrument and method of spectral, multispectral, hyperspectral, or other imaging using MSIA whereby a synchronized motion (y-axis) of the specimen relative to a monochrome p×m 2D array camera where p is the number of rows and m are the number columns in the array, and to the objective of the optical system (z-axis) under continuous or pulsed illumination to acquire several depth planes of a specimen and assemble them into a spectral, hyperspectral 3D volume image, and/or a 2D extended focus image, and/or z-stack image slices of the specimen in a single scan.

The advantages of the methods described herein may include, but are not limited to:
acquisition of multiple depth planes within a specimen from a single scan
elimination of multiple z-level scans to obtain depth planes from a specimen
camera tilt or specimen tilt is not required.
since z-levels are acquired in a single scan depth registration is achieved without using image processing algorithms.
Does not require color corrected optics, in particular objective lenses, significantly less expensive i.e., Plan Achromatic instead of Plan Apochromatic
Scan speed improvement: A specimen can be imaged by creating a focal plane consisting of three focus that is used as a reference focal plane about which the depth levels are acquired.

In summary, with narrow sensor windows in the direction of the scan, frames may be combined with little or no stitching artifacts at the boundaries between successive frames and scan strips. FIGS. 7a, 8a, 9a, 10a, and 11 therefore show examples of distortion-free constant-motion capturing multiple depth levels of specimens. FIGS. 12a, 12b, 13, 14, 15, 16a, and 16b shows examples of distortion free constant motion capturing multiple depth levels of thick specimens using MSIA imaging which is well suited to specimens with integration times of several milliseconds such as fluorescence or photoluminescence imaging such as in FIG. 4.

While the above description provides examples of one or more apparatus, methods, or systems, it will be appreciated that other apparatus, methods, or systems may be within the scope of the claims as interpreted by one of skill in the art.

What is claimed is:

1. A computer-implemented method for obtaining a three-dimensional image of a biological specimen, the method comprising operating a processor to:
capture, using a color or monochrome area sensor array, a first image of a first frame of the specimen at a first position, wherein the first frame comprises a plurality of pixel rows and represents an in-focus region of the specimen at a first depth level;
moving the specimen relative to the sensor array in a scanning direction by a predetermined number of pixel rows;
capturing a second image of a second frame of the specimen using the sensor array at a second position, wherein the second frame comprises the plurality of pixel rows and represents an in-focus region of the specimen at a second depth level, the second depth level being spaced apart from the first depth level in a direction perpendicular to the scanning direction; and
processing the first image and the second image to generate a three-dimensional image of the specimen.

2. The method of claim 1, wherein the specimen is moved at a constant velocity relative to the color or monochrome area sensor array in the scanning direction.

3. The method of claim 1, further comprising:
moving the specimen relative to the sensor array by the predetermined number of pixel rows;
capturing a third image of a third frame at a third position, wherein the third frame comprises the plurality of pixel rows and represents an in-focus region at a third depth level, the third depth level being spaced apart from both the first and second depth levels in the direction perpendicular to the scanning direction; and
processing the first, second, and third images to generate the three-dimensional image.

4. The method of claim 3, wherein the capture of the first image and the second image occurs after a first time interval, and the capture of the second image and the third image occurs after a second time interval, wherein the first and second time intervals are of equal duration.

5. The method of claim 3, further comprising:
capturing a fourth image of a fourth frame at a fourth position, wherein the fourth frame comprises the plurality of pixel rows and represents an in-focus region at a fourth depth level, the fourth depth level being spaced apart from the first, second, and third depth levels in the perpendicular direction to the scan direction; and
processing the first, second, third, and fourth images to generate the three-dimensional image.

6. The method of claim 3, wherein the fourth depth level is between the first and second depth levels in the direction perpendicular to the scanning direction.

7. The method of claim 1, wherein capturing the first image includes:
illuminating the specimen using a light source;
triggering the camera; and
opening a shutter of the camera to expose the sensor to light, wherein the light source remains on for a duration of the scan.

8. The method of claim 7, wherein the illumination is pulsed, and the pulse width is greater than the exposure time of the camera.

9. The method of claim 7, wherein the illumination is pulsed, and the pulse width is less than the exposure time of the camera.

10. The method of claim 1, wherein the light source comprises a color (RGB) light source.

11. The method of claim 1, wherein processing the images to generate the three-dimensional image includes applying Moving Specimen Image Averaging (MSIA).

12. An instrument for obtaining a three-dimensional image of a biological specimen, the instrument comprising:
a processor configured to:
capture a first image of a first frame of the specimen at a first position using a color or monochrome area sensor array, wherein the first frame comprises a plurality of pixel rows and represents an in-focus region at a first depth level;
move the specimen relative to the sensor array in a scanning direction by a predetermined number of pixel rows;
capture a second image of a second frame at a second position, wherein the second frame comprises the plurality of pixel rows and represents an in-focus region at a second depth level, spaced apart from the first depth level in a perpendicular direction to the direction of motion; and
process the first and second images to generate the three-dimensional image.

13. The instrument of claim 12, wherein the processor moves the specimen at a constant velocity in the scanning direction.

14. The instrument of claim 12, wherein the processor is further configured to:
capture a third image of a third frame at a third position, wherein the third frame represents an in-focus region at a third depth level spaced apart from the first and second depth levels; and
process the first, second, and third images to generate the three-dimensional image.

15. The instrument of claim 14, wherein the first, second, and third images are captured at equally spaced time intervals.

16. The instrument of claim 12, wherein capturing the first image includes:
illuminating the specimen using a light source;
triggering the camera; and
opening a shutter of the camera to expose the sensor to light, wherein the light source remains on for a duration of the scan.

17. The instrument of claim 16, wherein the illumination is pulsed, and the pulse width is greater than the exposure time of the camera.

18. The instrument of claim 16, wherein the illumination is pulsed, and the pulse width is less than the exposure time of the camera.

19. The instrument of claim 12, wherein the light source comprises a color (RGB) light source.

20. The instrument of claim 12, wherein the processing the first image and the second image to obtain the three-dimensional image of the specimen includes processing the first image and the second image using Moving Specimen Image Averaging (MSIA).
